(19) United States
(12) Patent Application Publication
(10) Pub. No.: US 2026/0288521 A1
(43) Pub. Date: Sep. 24, 2026

(54) METHODS AND SYSTEMS FOR USING CONTENT CONTRIBUTION VALUE TO DETERMINE MEMORY, STORAGE, CONTEXT WINDOW, AND MODEL PARAMETERS IN MACHINE LEARNING MODELS

(71) Applicant: VALENT TECHNOLOGIES, INC., Brookline, MA (US)

(72) Inventors: Alejandro Tomas Perez, Boston, MA (US); Anna Boone Reighart, Boston, MA (US)

(21) Appl. No.: 19/693,471

(22) Filed: May 31, 2026

Related U.S. Application Data
(63) Continuation-in-part of application No. 19/430,158, filed on Dec. 22, 2025.
(60) Provisional application No. 63/738,452, filed on Dec. 23, 2024.

(51) Int. Cl. G06F 9/50; G06F 11/3668; G06F 40/284; G06N 20/00

(52) U.S. Cl. CPC G06F 9/5016; G06F 11/3668; G06F 40/284; G06N 20/00

(57) ABSTRACT

Systems, methods, and computer-readable media determine allocation of model memory, storage, parameters, context window capacity, tokens, or training and inference resources based on contribution values of input data. A system can encode input data, segment the input data into input sequences, test a model with the input sequences, obtain output token or encoding sequences and logit values, and compute entropy, significance, weight of evidence, explanatory power, rarity, or salience to determine expected contribution values. Input sequences having low or negative contribution value can be discarded or reordered, and remaining input sequences can be retained for training, inference, fine tuning, reinforcement learning, or context-window assembly. The resulting allocation can reduce processing of low-utility data while optimizing memory, storage, and parameter resources of the model in training.

### CROSS-REFERENCE TO RELATED APPLICATIONS

The present application is a continuation-in-part (CIP) application to pending U.S. patent application Ser. No. 19/430,158 (attorney docket 276164) filed in the United States Patent and Trademark Office on Dec. 22, 2025, and titled “METHODS AND SYSTEMS FOR DETERMINING CONTRIBUTION VALUE OF CONTENT USED TO TRAIN MACHINE LEARNING MODELS,” which claims the benefit of U.S. Provisional Patent Application No. 63/738,452, filed in the United States Patent and Trademark Office on Dec. 23, 2024, and titled “DETECTING WHETHER A MACHINE LEARNING MODEL WAS TRAINED ON A GIVEN DATA POINT,” the entire contents of both of which are incorporated herein by reference in their entireties for all purposes.

### BACKGROUND

Machine learning models are commonly trained or operated using large volumes of content. In many implementations, the content is encoded into tokens, feature maps, feature vectors, embeddings, or other structured encodings and is then supplied to the model during training or inference. A model can allocate substantial memory, storage, processing time, and parameter capacity based on the amount of data supplied to the model and the number of tokens or encodings processed by the model. During inference, a model can also allocate a finite context window to input data that conditions an output. When the input data includes redundant, low-utility, or negative-utility content, the model can spend computational resources on data that provides limited informational benefit for the model operation being performed. If these resources allocations can be reduced, substantial cost savings and efficiency are obtainable.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

An embodiment includes computer-implemented techniques for determining allocation of memory, storage, model parameters, context window capacity, tokens, encodings, training steps, inference steps, or related model resources based on an expected contribution value of input data used by a model during training or inference. In some implementations of this disclosure, a system receives a model and input data, encodes the input data, segments the input data into input sequences for testing, sorts the input sequences into a sorted order for input to the model, and tests the model with each input sequence. The testing may include obtaining output token sequences or output encoding sequences and logit values correlated to each input sequence, and computing entropy, significance, weight of evidence, explanatory power, rarity, salience, or combinations thereof to determine an expected contribution value of each input sequence. Input sequences having an expected low or negative contribution value may be discarded or reordered, while remaining input sequences may be retained for allocation of memory, storage, model parameters, context window capacity, or other computational resources.

In some aspects of the disclosure, a non-transitory computer-readable medium stores instructions that, when executed by one or more processors, cause a system to determine memory, storage, or model parameter allocation based on expected contribution value of input data used by a model during training or inference. The instructions may cause the system to receive the model and the input data, encode the input data and segment the input data into input sequences for testing, sort the input sequences into a sorted order for input to the model, and test the model with each input sequence by obtaining output token sequences and logit values correlated to the input sequence. The instructions may further cause the system to discard or reorder input sequences having an expected low or negative contribution value, retain remaining input sequences, and allocate memory, storage, or model parameters for the remaining input sequences. In some implementations of the disclosure, the instructions may further cause the system to determine whether an input sequence was seen during training or inference, terminate testing when sufficient evidence is obtained, or report an inconclusive result when sufficient evidence is not obtained.

In some implementations, the disclosed techniques may be applied to inference by determining a context window allocation based on expected contribution value of input data used by a model during inference. A system may initially allocate a model context window, segment input data into input sequences, perform contribution value and ordering evaluation for the input sequences, assess contribution value across the system for context window utility, discard or reorder input sequences having low or negative contribution value, retain an optimal subset of input sequences, and allocate an optimal number of tokens for the model context window. In some implementations, the input data may include text, audio, video, images, music, mixed-modality data, or other data, and encoding may include tokenizing input data to obtain token sequences representative of the input data, computing feature maps of video or images, computing feature vectors of audio or music, or producing other encodings suitable for processing by the model.

In other implementations of the disclosure, the disclosed techniques may be applied to training, fine tuning, or reinforcement learning by selecting input sequences and model parameters based on contribution value. A processor may supply input content to a model and obtain corresponding outputs from the model, and a model encoder may encode the input content into encodings representative of the input content. The processor may perform plural tests in relation to the model for each input sequence and corresponding output sequence, combine results of the plural tests to obtain a contribution value for the input sequence, discard or reorder input sequences having expected low or negative contribution value, and retain remaining input sequences. The processor may then train, perform inference with, fine tune, or perform reinforcement learning on the model using the retained input sequences, and may allocate memory, storage, model parameters, or context window capacity based on the retained input sequences. In some implementations, test ordering may be determined by ranking tests or input sequences based on expected contribution value, and determinations of significance and entropy may compare output sequences with ground truth tokens while determinations of weight of evidence and explanatory power may compare one of the tests or input sequences with a model vocabulary.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram illustrating the encoding of a datapoint into a token sequence.

FIG. 2A is a system overview diagram illustrating a local computer implementation for determining contribution values of content used by a model.

FIG. 2B is a system overview diagram illustrating a cloud-based implementation for determining contribution values of content used by a model.

FIG. 3 is a flow chart illustrating a method for determining contribution values of content used by a model.

FIG. 4 is a flow chart illustrating a method for determining and reporting verbatim outputs and contribution values for content evaluated by a model.

FIG. 5 is a flow chart illustrating a method of determining a contribution value of content used by a model.

FIG. 6 is a flow chart illustrating a method for determining and reporting contribution values of content evaluated by a model, including sorting tests for execution.

FIG. 7 is a diagram illustrating an original input passage and a model-generated verbatim output with corresponding token sequences.

FIG. 8 is a flow chart illustrating a method for determining when sufficient test data has been collected to evaluate uniqueness of a datapoint for a model.

FIG. 9 is a flow diagram illustrating a method for determining whether sufficient confidence has been achieved in contribution value determinations for content evaluated by a model.

FIG. 10 is a schematic illustration showing segmentation of a text datapoint into multiple input and expected-output test pairs for evaluation by a model.

FIG. 11 is a schematic diagram illustrating enumeration of tests from a datapoint and sorting of the tests for evaluation by an ordering function.

FIG. 12 is a schematic diagram illustrating test execution and logging for multiple model queries using different seeds and comparing token output sequences to ground truth token sequences.

FIG. 13 is a schematic diagram illustrating execution of a test on a model to compute contribution values for a datapoint.

FIG. 14 is a diagram illustrating example equations for calculating contribution value for a datapoint and for individual tests.

FIG. 15 is a diagram illustrating Shannon entropy equations used to characterize encoded or tokenized sequences.

FIG. 16 is a diagram illustrating Fisher Information equations used for significance calculations in contribution value determinations.

FIG. 17 is a diagram illustrating a weight of evidence equation used for evaluating tests performed in relation to a model.

FIG. 18 is a schematic diagram illustrating explanatory power and information value equations expressed through mutual information formulations.

FIG. 19 is a flow chart illustrating a workflow for obtaining a sorted test sequence by evaluating randomized test orderings until a sufficient statistic is reached.

FIG. 20 is a flow diagram illustrating operation of a sorting function for ordering candidate test sequences based on expected sufficiency.

FIG. 21 is a flow chart illustrating optimization of model memory, storage, and model parameters based on contribution values of input sequences used for training.

FIG. 22 is a flow chart illustrating allocation of a model context window based on contribution values of segmented input sequences during inference.

FIG. 23 is a flow chart illustrating a process for selecting input sequences and model parameters for fine tuning or reinforcement learning based on contribution value.

### DETAILED DESCRIPTION

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting.

For purposes of reading the description of the various implementations below, the following descriptions of the sections of the Specification and their respective contents may be helpful:

There is a need for methods and systems that can analyze the relationship between input content and model outputs at the token/encoding level, evaluate the rarity, salience, and significance of specific sequences, and combine these results to quantify the contribution value of content to a model. Such approaches also support the detection of whether particular content was used by a model during training or inference, even in the presence of stochastic generation procedures or post-training modifications. By addressing these needs, improved solutions can provide a foundation for optimal model performance and resource savings including for compute, energy, memory and storage, as well as content attribution, transparent content valuation, and an efficient market place for content in the context of machine learning model development and deployment.

Machine learning models that use data/content that has high contribution value during training or inference offer significant advantages in terms of efficiency, performance, and resource management. When data/content leads to a more substantial reduction in loss, improved accuracy in less time, or minimization/maximization of values measured by a given objective function, it possesses a higher contribution value, meaning it directly improves the efficiency of the model's learning process, inference and other outcomes. Importantly, if two data sequences yield the same overall improvement but differ in length, the tokens/encodings in the shorter data sequence (having fewer) carry a higher per-token (or per-encoding) contribution value, further boosting efficiency.

Prioritizing data with high contribution values minimizes the number of tokens or encodings required to achieve desired performance improvements. This in turn reduces the number of steps for both training and inference, each of which demands time, computational power, and energy. By decreasing the token/encoding count and focusing on more impactful data, organizations can lower the cost and duration of all stages of model development, including but not limited to model training, fine-tuning, in-context learning, and inference. Expenses associated with compute resources, energy consumption, and even human labor are all reduced when fewer, more valuable token/encodings drive model development and deployment/inference.

Beyond computational savings, high contribution value data positively impacts memory and storage requirements. Models typically allocate substantial memory under the assumption that many token/encodings are necessary per training step and for inference. However, choosing token/encodings with greater utility means less memory is needed per step, and data storage can be optimized by avoiding redundant or unnecessary data. By identifying which data has already been used, retraining on the same information can be prevented—saving storage space and computational effort. Moreover, attributing the sources of high contribution-value data allows for more targeted future training, using only the most effective datasets.

The same memory efficiency gains apply to the context window (i.e., the input given to the model when it is used). A model that has already been trained can be used with a smaller context window, without changing the model, if the data included in the context window has higher contribution value. A smaller context window means the model will use less memory while it is running, and therefore the model is more efficient at inference.

The prior approaches available lack one or more of the following advantages provided by the present disclosures:
a) ability to use derandomization techniques to characterize the internal representation and behavior of statistical and probabilistic models;
b) ability to deterministically recreate specific model outputs;
c) ability to analyze raw model output (i.e., unprocessed and unnormalized values before they are processed and converted into probabilities or encodings or embeddings);
d) ability to identify the ground truth as it is represented in the raw model output;
e) ability to measure the effects a given datapoint had or would have as they relate to the representational capacity of a given model given the information currently represented in the model parameters and weights;
f) ability to measure sufficiency and confidence in results obtained through the analysis; and
f) ability to measure and minimize the amount of computational resources needed to conclusively analyze a datapoint as it relates to a given model before the analysis begins.

This disclosure relates to machine learning models and, more particularly, to techniques for evaluating input data used with a model during training, fine tuning, reinforcement learning, in-context learning, or inference. Such models can include, for example, large language models, transformer-based models, neural network models, and other predictive computational models that process text, audio, video, images, music, mixed-modality data, or other forms of data. In particular, the disclosure relates to determining contribution values, expected information gain, or utility of input data and using those determinations to allocate or reduce memory, storage, context window capacity, model parameters, training steps, inference steps, tokens, encodings, or related computational resources. These allocation measures help in reducing the costs of compute, memory and energy. By reducing these costs model use becomes more efficient, scaleable and more widely used.

Existing approaches for selecting or evaluating input data often rely on indirect measures, processed probability values, perplexity, similarity scores, compression-based estimates, or manual curation. These approaches are not adequate and can provide limited information about how a particular datapoint, input sequence, or encoded segment contributes to a model objective, affects model behavior, or supports a determination that content was previously used by the model during training or inference. Existing approaches can also fail to provide a reproducible basis for deciding whether to retain, discard, reorder, or prioritize input sequences for training, fine tuning, reinforcement learning, in-context learning, or inference.

The technology described in the parent disclosure provides methods and systems for determining contribution value of content used by a machine learning model and for determining whether content was used by a model during training or inference. The technology can encode content into input sequences and corresponding ground truths, define and execute plural tests in relation to a model, obtain model outputs and logit values, compute metrics such as rarity, salience, entropy, significance, weight of evidence, and explanatory power, and combine the results to determine contribution value at a token, encoding-sequence, datapoint, or content level. Such contribution value technology can provide a basis for assessing which input sequences are expected to provide greater or lower utility to a model.

There remains a need for improved techniques that use contribution value or expected information gain determinations to manage and allocate model resources. For example, there is a need for techniques that can identify input sequences having low or negative contribution value, discard or reorder those input sequences, retain input sequences having greater expected utility, and allocate memory, storage, context window capacity, model parameters, or training and inference resources based on the retained or reordered input sequences. Such techniques can be used in connection with training, inference, fine tuning, reinforcement learning, or other model operations to improve resource allocation while preserving or enhancing useful model behavior.

Another aspect of the present disclosure is that identifying data that has low or negative contribution value is useful information for preventing unnecessary use of memory and storage resources and computational efforts. Low or negative contribution values represent data that is redundant/unnecessary/detrimental for a given model as measured by the relevant objective function. Some examples are, data the model has already seen during training (which would lead to over-fitting or wasteful computation), data the model is already familiar with during in-context learning (which would lead to unnecessary allocation of tokens in its finite context window), and data that does not lead to a higher reward during fine-tuning (which would lead to more time and resources devoted to the process). Low or negative contribution value data will likely lead to inefficient model development, deployment and use of resources.

In summary, selecting data with the highest contribution value—also referred to as information gain or utility—drives model development efficiency across all stages. Whether training, fine-tuning, in-context learning, or inference, models benefit from improved performance using fewer resources. If a model is already trained, the method can be used to select data for fine-tuning (post-training) and normal usage/inference (e.g., selecting the data that is put in the context window to answer a question). This approach not only streamlines the learning process but also leads to considerable savings in memory, storage, time, compute, and overall operational costs (including labor) across training, post-training and normal model usage/inference.

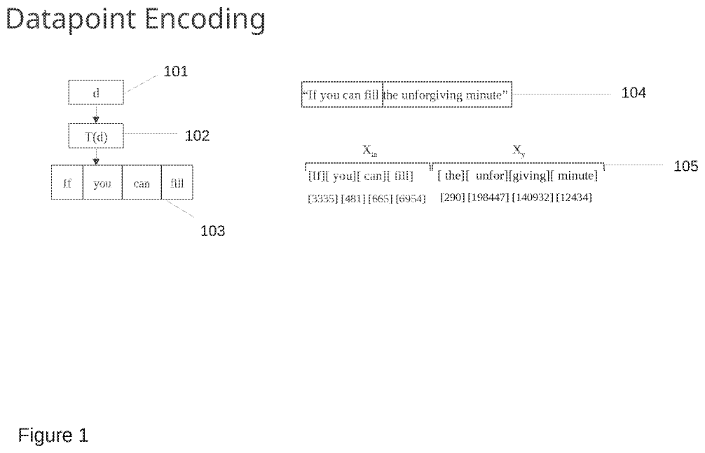

FIG. 1 is a schematic diagram that illustrates the process of encoding a raw datapoint sequence (e.g. article, book, poem, video, music score, or other data) into structured tokenized input and output representations for use in model analysis. The figure begins with a raw datapoint symbol, designated as element 101, which represents the original content or data sample to be analyzed by the system. The term “raw datapoint symbol,” as used herein, refers to any unprocessed input that serves as the starting point for subsequent encoding and analysis operations. Examples of such raw datapoint symbols may include, without limitation, sentences, paragraphs, document excerpts, images, music, video or any other form of unstructured data. In this example, the raw text is processed by a tokenization (or encoder) function, indicated as element 102, which operates to convert the input text into a sequence of discrete tokens based on a predefined vocabulary. The term “tokenization function” refers to a computational process or algorithm that segments a text sequence into constituent tokens, where each token corresponds to a unit such as a word, subword, or symbol, and is mapped to a unique identifier in the model's vocabulary. Examples of tokenization functions may include, without limitation, byte pair encoding, unigram language model tokenization, or whitespace-based token splitting. The output of the tokenization function is shown in the figure as a sequence of tokens/encodings, labeled 103, where each token is visually represented as an individual box corresponding to a segment of the original text. The figure further presents a full example text sequence, denoted by element 104, which serves as an illustrative input for demonstrating the encoding process. This example text is segmented into two primary components for analysis: an input token sequence Xin and an output token sequence Xy, collectively referenced as element 105. The term “Xin” refers to the contiguous subset of tokens derived from the initial portion of the tokenized datapoint that is provided as input to the model, while the term “Xy” refers to the subsequent subset of tokens that represent the ground truth completion for the given input. Examples of input token sequences may include, without limitation, the first n tokens of a sentence, a prompt extracted from a document, or a context window of tokens preceding a prediction target. Examples of output token sequences may include, without limitation, the next m tokens following the input, a completion sequence, or a reference answer for evaluation. Each token in Xin and Xy is annotated with a corresponding numeric token identifier, which uniquely specifies its position in the model's vocabulary and facilitates downstream processing and evaluation. Collectively, the elements depicted in FIG. 1 illustrate the transformation of raw text into structured token sequences that are suitable for subsequent model evaluation and analysis, as described in the present disclosure. The process of encoding a datapoint in this manner enables the system to systematically partition content into input and ground truth completion sequences, assign unique identifiers to each token, and prepare the data for token-level analysis by a machine learning model. The subsequent paragraphs will further detail the roles and functions of each group of components shown in FIG. 1, and will explain how these elements support the broader system and method of the present disclosure for determining whether a model was trained on specific content or data and its content valuation using token-level analysis.

While aspects of the present disclosure are presented using encoding text into tokens (tokenizing text), the present disclosure is not limited thereto. Other types of encodings, for example, include feature maps computed by convolutional neural networks for images, audio signals, video frames, time series data, and/or any other forms of data that can be processed by the model to condition its output and/or behavior. Encodings can also jointly include more than one data type, such as image/text pairs to classify images (e.g., descriptions in text tokens alongside encoded pixels), audio/text pairs (e.g., lyrics in text tokens alongside audio encoded techniques like discrete Fourier transform (DFT)), and video/text pairs (e.g., descriptions in text tokens alongside encoded video clips).

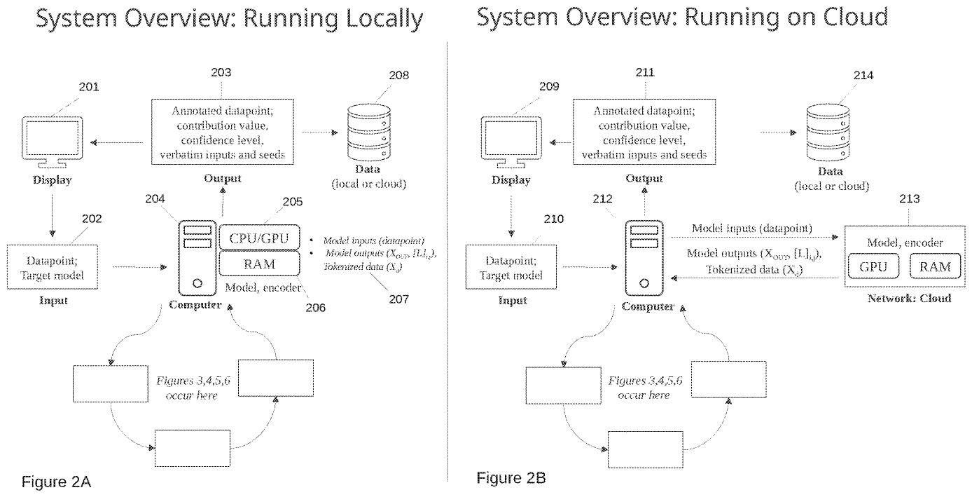

FIG. 2A and FIG. 2B provide system overview diagrams that illustrate, respectively, local and cloud-based implementations for determining attribution and contribution values of content used by a model during training or inference. In both configurations, the process begins with the provision of an input datapoint and a target model, identified as elements 202 and 210, which serve as the initial elements supplied to the system for analysis. The term “input datapoint,” as used herein, refers to any discrete unit of content or data sample that is evaluated for its informational contribution to a machine learning model. Examples of input datapoints may include, without limitation, text passages, audio clips, image files, video segments, or other forms of structured or unstructured data. The term “target model” refers to the specific machine learning or language model under evaluation for content contribution, and may include, without limitation, neural network models, transformer-based models, or other predictive computational models. In the local implementation depicted in FIG. 2A, a local computer 204 functions as the primary processing unit, equipped with computational resources such as a central processing unit (CPU) or graphics processing unit (GPU) and random access memory (RAM), referenced as elements 204, 205, and 206. The term “local computer” refers to any computing device or workstation that executes the contribution value determination of the present disclosure within a user-controlled environment. This system need not be user controlled. Examples of local computers may include, without limitation, desktop computers, laptops, or dedicated servers. The model and encoder, also represented by elements 204, 205, and 206, are responsible for processing the input datapoint and generating model outputs (represented by element 207) necessary for content attribution or contribution value analysis. The term “model and encoder” refers to the combination of a machine learning model and its associated tokenization or feature extraction mechanism, which together enable the transformation of raw input data into a format suitable for model inference. Examples of model and encoder combinations may include, without limitation, a language model paired with a byte pair encoding tokenizer, or an image classification model paired with a convolutional feature extractor. The output of the contribution value determination is an annotated datapoint, shown as element 203, which includes metrics such as contribution value, confidence level, and records of verbatim inputs and random seeds used during model evaluation. The term “contribution value” includes but is not limited to the measurement of expected information gain or utility that an unseen datapoint could provide for improving the predictive capability for a target model if used by a model during training or inference, or the information gain or utility that a seen datapoint has already contributed to the target model. The term “annotated datapoint output” refers to a data object or record that encapsulates the results of the contribution analysis, including quantitative and qualitative indicators of informational value. Examples of annotated datapoint outputs may include, without limitation, structured reports, database entries, or serialized data files containing contribution scores and associated metadata. Data storage for the local system is provided by local data storage 206 and may be extended to a local or cloud data repository 208, enabling persistent retention of both input and output data. Data storage locally or on the cloud is optional.

In the cloud-based implementation illustrated in FIG. 2B, a local computer client 212 communicates with remote computational resources over a cloud network connection 213. The term “local computer client” refers to a user-facing device that interfaces with cloud services to initiate and manage the contribution value determination process. Examples of local computer clients may include, without limitation, personal computers, tablets, or thin clients. The remote resources, which include a model and encoder hosted on cloud-based GPU and RAM infrastructure, perform the encoder and model processing and return model outputs and tokenized data to the client. An annotated datapoint output 211, is generated by the client after processing the model outputs and tokenized data. Data storage in this configuration is managed by a remote data repository 214, which may reside on cloud-based storage platforms, distributed file systems, or within local data storage. Data storage is optional.

Each of the system components described in FIG. 2A and FIG. 2B corresponds to various claim limitations regarding the use of a processor for model input, a model encoder for data transformation, and optional storage elements for retaining results. Subsequent paragraphs will further detail the operations of the local and cloud systems, including the specific flow of data and the sequence of processing steps involved in determining attribution and contribution values for content used to train a model.

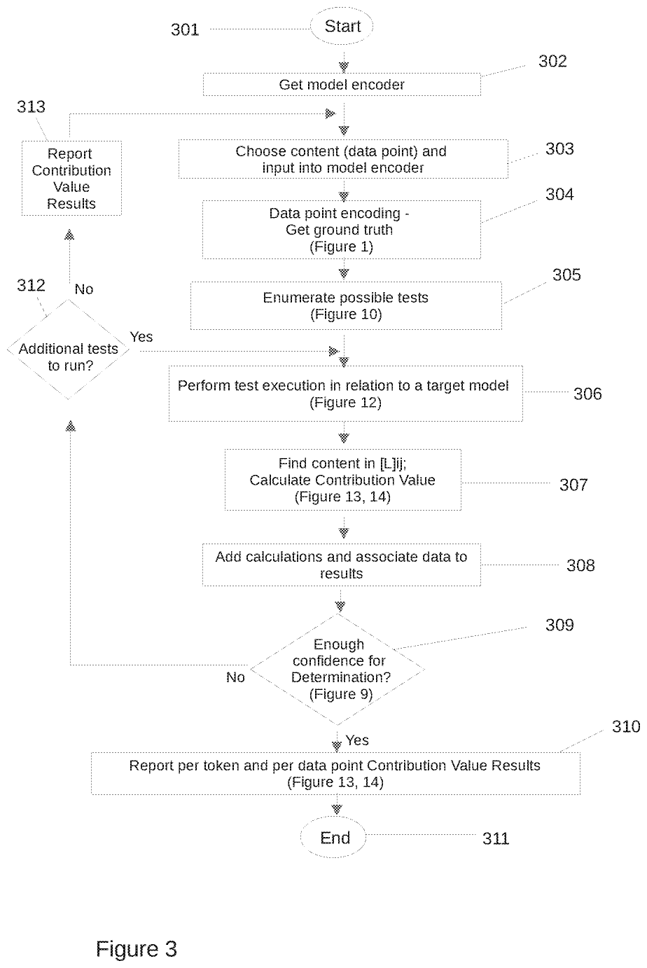

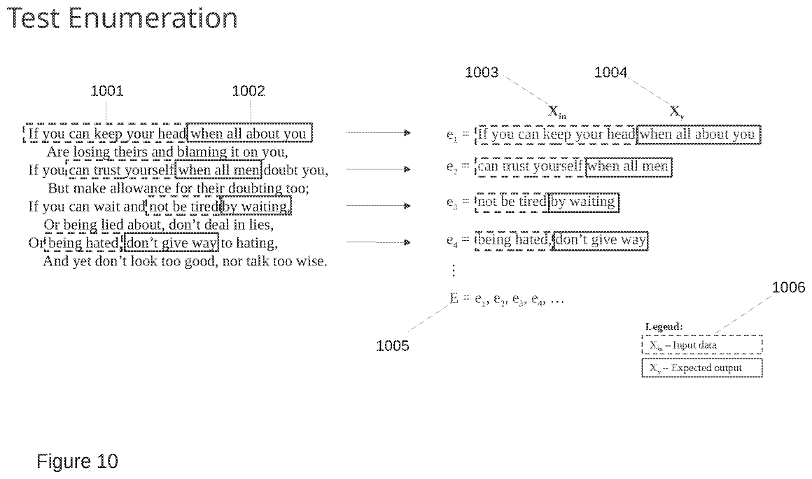

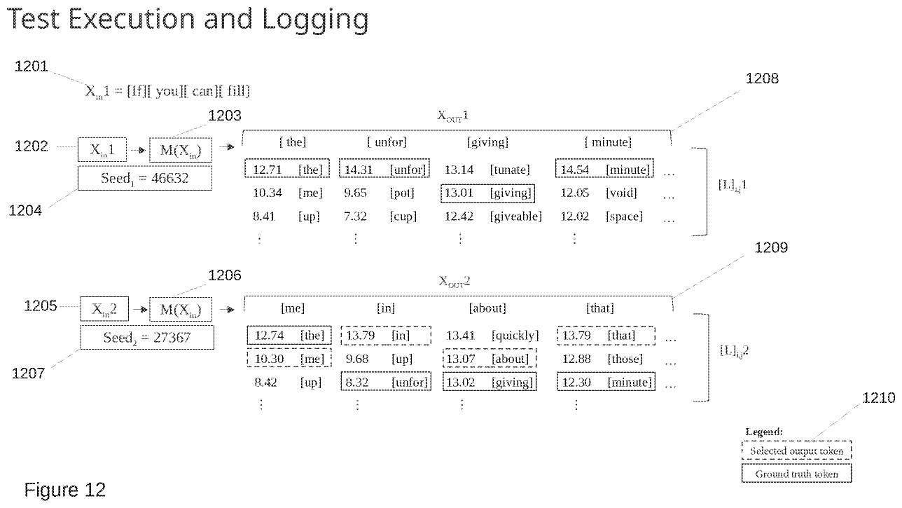

FIG. 3 is a flow chart that illustrates a method for determining contribution values of content used by a model during training or inference by depicting a sequence of process steps, each corresponding to a distinct functional component in the overall workflow. The process is bounded by a start node 301 and an end node 311, which respectively mark the initiation and completion of the contribution value determination procedure. The method begins with a ‘get model encoder’ step 302, in which the system acquires or initializes a model encoder for the target model under evaluation. The term “model encoder,” as used herein, refers to a computational module or algorithm that transforms raw input data into a structured representation suitable for processing by a machine learning model, such as converting text into token sequences or extracting features from non-textual data. Examples of model encoders may include, without limitation, tokenizers for language models, feature extractors for image or audio data, or embedding generators for structured datasets (See FIG. 1 and discussion earlier). Following this, the ‘choose content and input’ step 303 involves selecting a specific content item or datapoint and providing it as input to the model encoder. The term “content,” as used herein, refers to any data sample or information unit whose contribution to model training is to be evaluated, and may include, without limitation, text passages, audio clips, images, video frames, or other forms of digital content. The ‘data point encoding and ground truth acquisition’ step 304 entails encoding the selected content using the model encoder and obtaining the corresponding ground truth tokens for subsequent comparison. The ‘enumerate possible tests’step 305 generates a set of tests to be performed in relation to a target model (discussed further with respect to FIG. 10), where each test assesses the model's response to a specific input sequence and its ability to generate corresponding output tokens. The ‘perform test execution in relation to a target model’ step 306 executes these tests, generating model outputs and collecting relevant metrics, which will be further discussed with reference to FIG. 12.

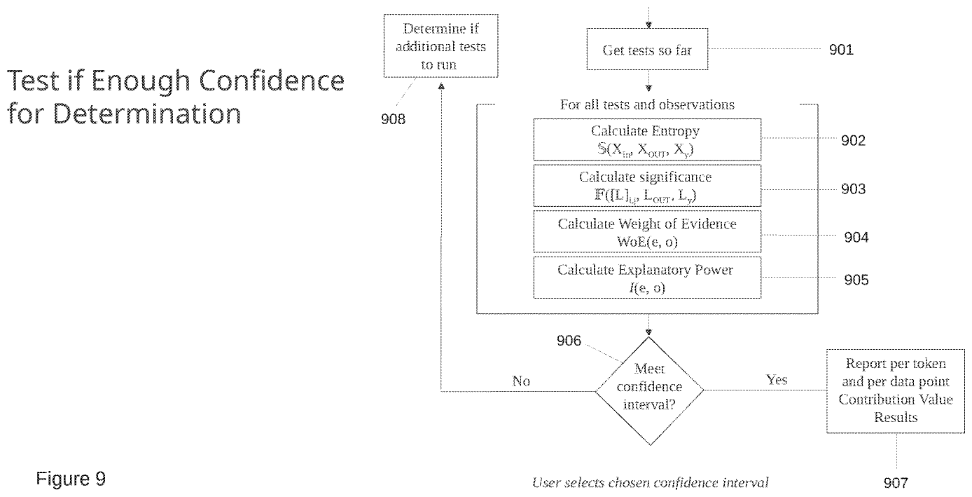

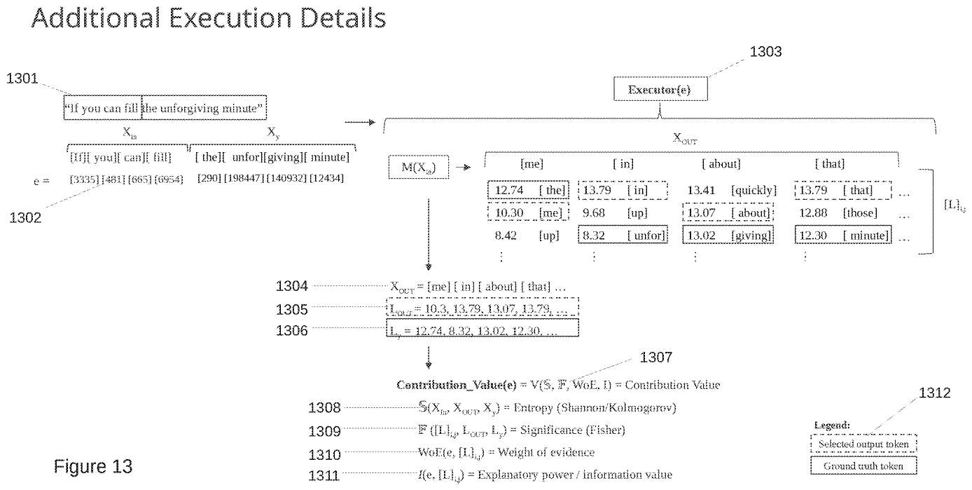

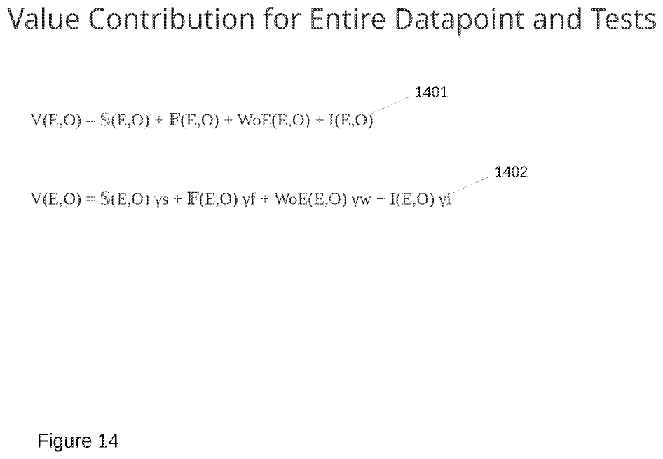

In the ‘find content in logit matrix and calculate contribution value’ step 307 (further discussed with reference to FIGS. 13, 14), the system analyzes the logit matrix produced by the model to identify relevant content and compute a contribution value for each token/encoding sequence. The term “logit matrix,” as used herein, refers to a multidimensional array or table containing the unnormalized prediction scores assigned by the model to each token in the vocabulary at each generation step. Examples of logit matrices may include, without limitation, arrays of real-valued scores output by neural network layers or tables of token-level prediction values prior to softmax normalization. The ‘add calculations and associate data to results’ step 308 aggregates the calculated contribution values and associates them with the corresponding content and test results. The ‘evaluate confidence for determination’ step 309 (further discussed with reference to FIG. 9) assesses whether the accumulated evidence is sufficient to make a reliable determination regarding the contribution value, while the ‘report per token and per data point contribution value results’ step 310 (further described with reference to FIGS. 13, 14) outputs and/or stores detailed results for each token and content item analyzed. The ‘contribution value results summary’ step 313 provides an overall summary of the findings. The additional tests to run decision branch 312 enables iterative testing by allowing the process to repeat certain steps if further evaluation is required to reach a desired confidence level. Each process step in FIG. 3 corresponds to specific claim limitations regarding receiving a model encoder, inputting content, encoding data, defining and performing tests, and combining results to determine contribution value. Subsequent paragraphs will discuss alternative process flows such as determining verbatim output, sorting the tests and others.

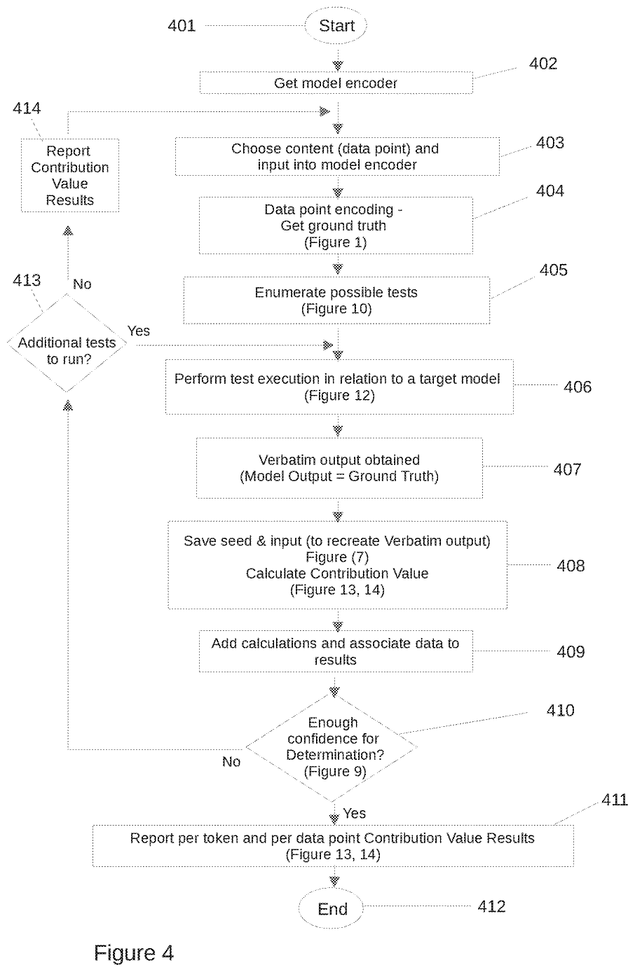

FIG. 4 is a flow chart illustrating a method for determining and reporting on verbatim outputs obtained from the model and the contribution values of the associated content used by a model during training or inference, with the process bounded by a start node 401 and an end node 412. The method performed by the processors in the FIGS. 2A, 2B, comprises a sequence of steps, beginning with obtaining a model encoder at step 402, refers to the computational module or algorithm that transforms raw input data into a structured representation suitable for processing by a machine learning model (See FIG. 1). The next step, ‘choose content and input’ at 403, involves selecting a specific content item or datapoint and providing it as input to the model encoder. As discussed earlier, the term “content,” as used herein, refers to any data sample or information unit whose contribution to model training is to be evaluated, and may include, without limitation, text passages, audio clips, images, video frames, or other forms of digital content. This is followed by data point encoding and ground truth acquisition at step 404, where the selected content is encoded and the corresponding ground truth tokens are obtained for subsequent comparison (See FIG. 1).

The method proceeds to enumerate possible tests at step 405 (See FIG. 10), defining a set of tests to be performed in relation to a target model, where each test is designed to assess the model's response to a specific input sequence and its ability to generate corresponding output token sequences. The term “test,” as used herein, refers to an evaluation instance in which a defined input sequence is provided to the model and the resulting output is analyzed for contribution value. Examples of tests may include, without limitation, input-output token pair evaluations, sequence completion tasks, or classification challenges. Step 406 involves performing test execution in relation to a target model, generating outputs and collecting relevant metrics (See FIG. 12).

At step 407, the process checks whether verbatim output has been obtained, that is, whether the model output matches the ground truth exactly. The term “verbatim output” refers to a model-generated output sequence that is identical to the expected ground truth tokens for a given input, serving as evidence of potential memorization or direct training data usage. Examples of verbatim output may include, without limitation, exact text matches, pixel-perfect image reconstructions, or byte-for-byte audio reproductions. If verbatim output is detected, step 408 saves the seed and input used to recreate the verbatim output and calculates the contribution value (See FIGS. 13, 14). The term “seed,” as used herein, refers to a value used to initialize the random number generator within the model to ensure deterministic output generation for reproducibility. Examples of seeds may include, without limitation, integer values, hash-derived values, or timestamp-based initializations. Step 409 aggregates the resulting calculations and associates the related data to overall results (e.g. FIG. 14 functions).

The process may end here and report the determination of a verbatim output and/or store the verbatim output, input sequence and associated seed. Alternatively, as shown in FIG. 4, it may alternatively proceed to a decision point at step 410, which evaluates whether there is enough confidence for a determination regarding the contribution value. If sufficient confidence is not reached (See FIG. 9), the process checks at step 413 whether additional tests remain to be run; if so, the method loops back to perform further testing, and if not, proceeds to step 414 to report and/or store contribution value results. When the confidence condition is satisfied, the method proceeds to step 411 to report per-token and per-data point contribution value results before terminating at end node 412. This flow chart highlights key decision points for confidence evaluation and additional testing, and correlates to claim limitations regarding verbatim output detection, seed storage, and contribution value calculation. Subsequent paragraphs will address further variations to the process flow of the present disclosure.

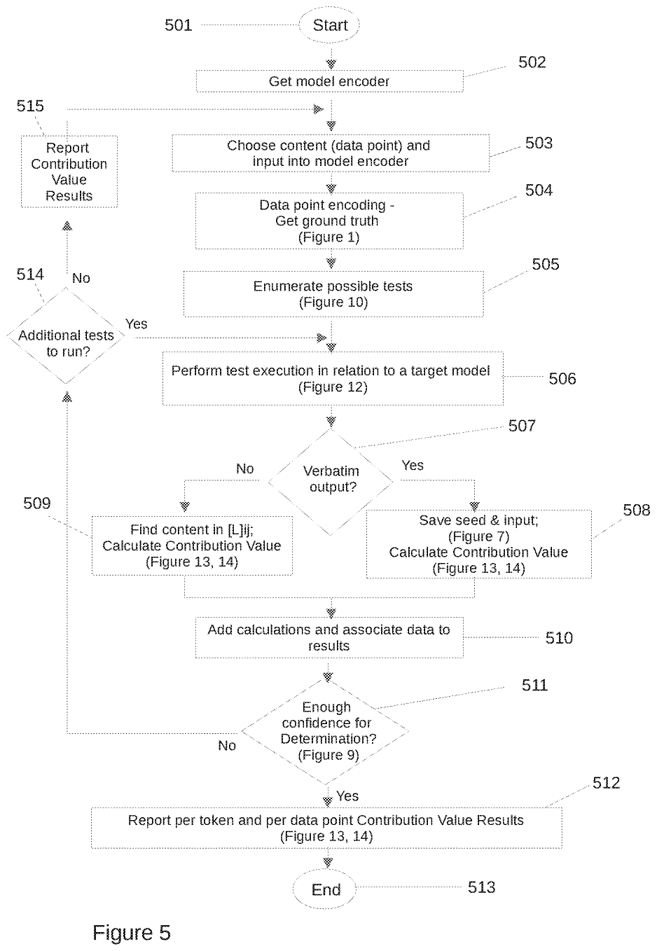

FIG. 5 is a flow chart illustrating a method, similar to ones discussed with reference to FIGS. 3 and 4, of determining a contribution value of content used by a model during training or inference, depicting a sequence of process blocks and decision points that collectively define the evaluation workflow. This process determines the contribution value of the content regardless of whether verbatim outputs were identified.

The process initiates at a start node 501 and concludes at an end node 513, establishing the boundaries of the method. The method begins with a ‘get model encoder’ step 502, in which the system acquires or initializes a model encoder for the target model under evaluation. Following this, the ‘choose content and input’ step 503 involves selecting a specific content item or datapoint and providing it as input to the model encoder. The ‘data point encoding and ground truth acquisition’ step 504 entails encoding the selected content using the model encoder and obtaining the corresponding ground truth tokens for subsequent comparison. The ‘enumerate possible tests’ step 505 defines a set of tests to be performed in relation to a target model, where each test is designed to assess the model's response to a specific input sequence and its ability to generate corresponding output token/encoding sequences. The term “test,” as used herein, refers to an evaluation instance in which a defined input sequence is provided to the model and the resulting output is analyzed for contribution value. At decision point 507, the method evaluates whether the model output is verbatim, that is, whether the generated output matches the ground truth exactly. The term “verbatim output” as discussed earlier refers to a model-generated output sequence that is identical to the ground truth tokens for a given input, serving as evidence of potential memorization or direct training data usage. Examples of verbatim output may include, without limitation, exact text matches, pixel-perfect image reconstructions, or byte-for-byte audio reproductions. If verbatim output is detected, the process proceeds to step 508, where the seed and input used to recreate the verbatim output are optionally saved and the contribution value is calculated. If the output is not verbatim, the method advances to step 509, where the system analyzes the logit matrix produced by the model to identify relevant content and compute a contribution value for each output token/encoding sequence (See FIGS. 13, 14). The term “logit matrix” refers to a multidimensional array or table containing the unnormalized prediction scores assigned by the model to each token in the vocabulary at each generation step. Examples of logit matrices may include, without limitation, arrays of real-valued scores output by neural network layers or tables of token-level prediction values prior to softmax normalization. The add calculations and associate data to results step 510 aggregates the calculated contribution values and associates them with the corresponding content and test results. The confidence level determination decision point 511 assesses whether the accumulated evidence is sufficient to make a reliable determination regarding the contribution value. If sufficient confidence is reached, the report per token and per data point contribution value results step 512 outputs (and/or stores) detailed results for each token and content item analyzed. If further evaluation is required, the additional tests to run decision point 514 enables iterative testing by allowing the process to repeat certain steps, and the report contribution value results step 515 provides an overall summary of the findings.

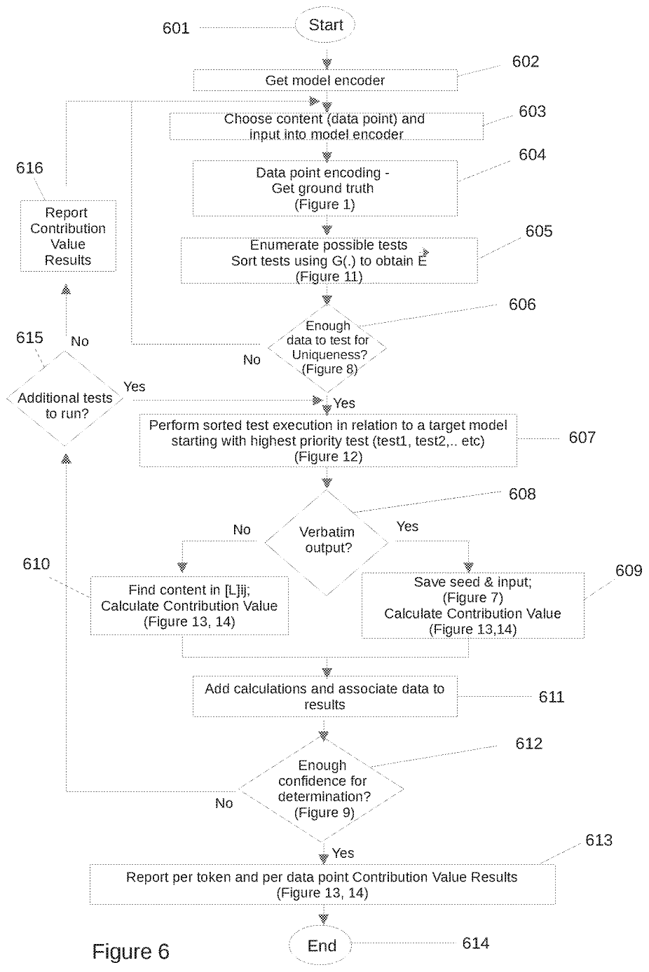

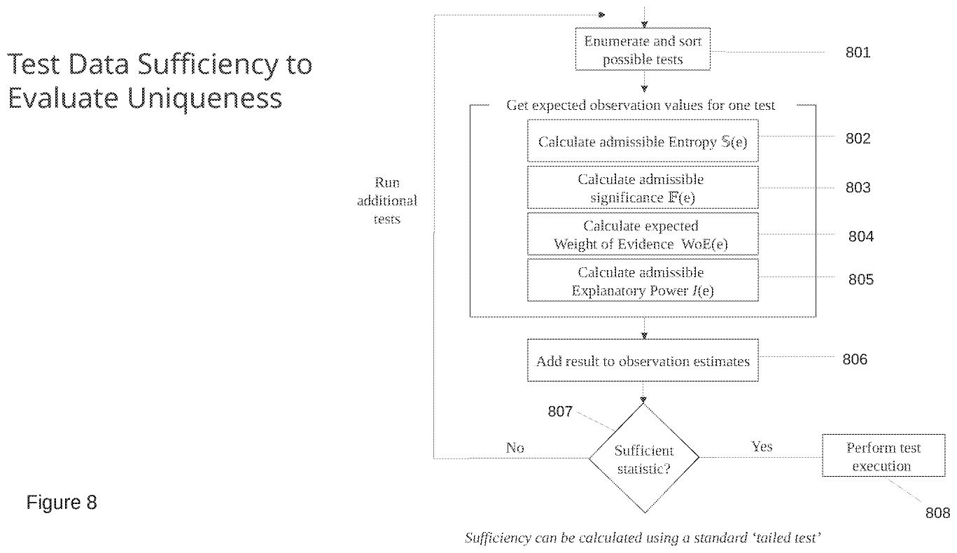

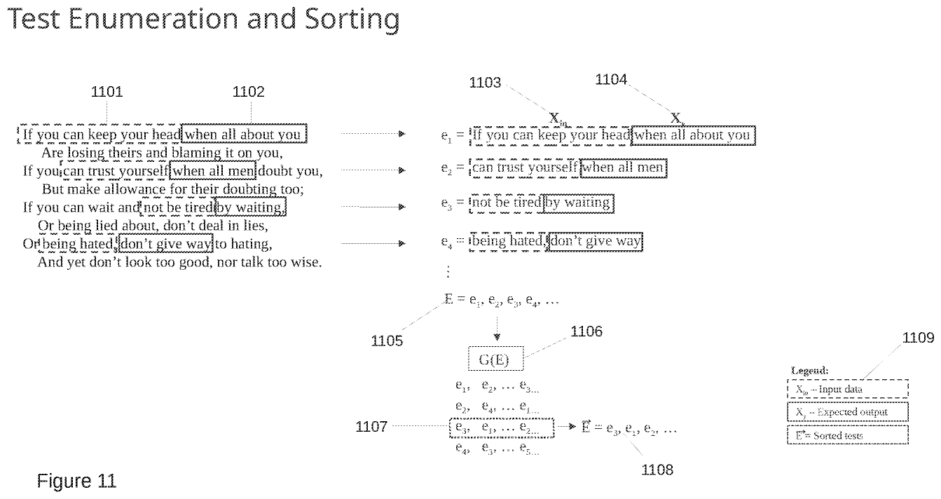

FIG. 6 is a flow chart that illustrates a method for determining and reporting contribution values of content used by a model during training or inference, with particular emphasis on the sorting and prioritization of tests (See FIG. 11). The process begins at a start node 601 and concludes at an end node 614, delineating the operational boundaries of the method. The method comprises a series of process steps, including obtaining a model encoder at step 602, choosing content and input at step 603, encoding the data point and acquiring ground truth at step 604, and enumerating and sorting possible tests at step 605 using G function (discussed in detail with reference to FIG. 11). The term “test,” as used herein, refers to a defined evaluation instance in which a specific input sequence is provided to the model and the resulting output is analyzed for contribution value. Examples of tests may include, without limitation, input-output token pair evaluations, sequence completion tasks, or classification challenges. At step 606, a decision block evaluates whether sufficient data is available to test for uniqueness (See FIG. 8), and if so, the method proceeds to perform sorted test execution at step 607, beginning with the highest priority test as determined by the sorting function. The term “sorting function,” as used herein, refers to a computational process that ranks or orders tests based on criteria such as expected information value, rarity, or salience, with the purpose of optimizing the sequence in which tests are performed to maximize efficiency and confidence in the results. Examples of sorting functions may include, without limitation, algorithms that prioritize tests with rare token combinations, high expected contribution value, or maximal explanatory power. The process continues with a verbatim output decision at step 608, followed by either saving the seed and input sequence and calculating contribution value at step 609 if verbatim output is determined, or if not verbatim, finding content in the logit matrix and calculating contribution value at step 610. Calculations are then aggregated and associated with results at step 611, and a determination is made at step 612 as to whether a sufficient confidence level has been achieved for a final determination. If so, the method reports (and/or stores) per token and per data point results at step 613; otherwise, it evaluates at step 615 whether additional tests remain to be run, and if not, proceeds to report overall contribution value results at step 616. The role of test sorting and prioritization is central to this process, as it enables the system to efficiently allocate computational resources and reach determinations with high confidence using a minimal number of tests. This approach correlates to claim limitations regarding the performance of tests in a sorted order and the evaluation of confidence in test results.

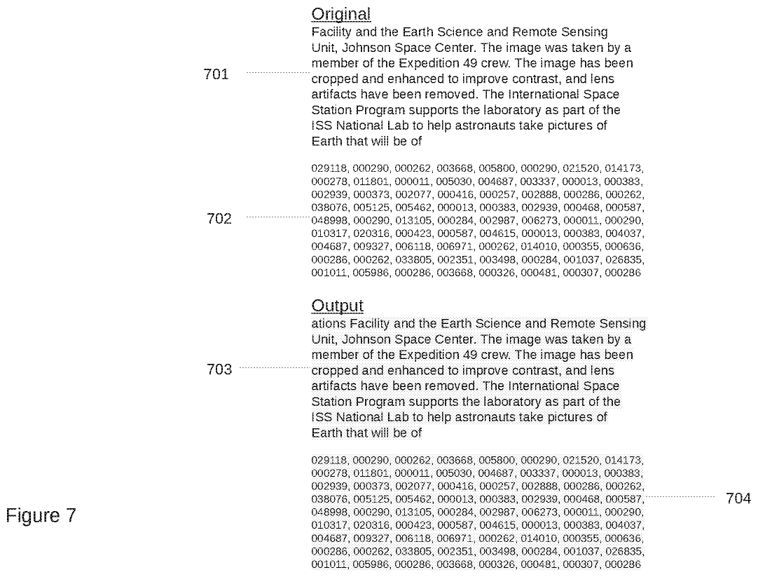

FIG. 7 is a diagram illustrating a model's ability to generate an output token sequence that is a verbatim match to the ground truth output sequence (further explained through the code snippet in Table A below). This diagram was created by a seeded deterministic language model, for which the specific code is referenced below. The figure presents an original input text passage 701, which serves as the source content for analysis, and a corresponding tokenized representation 702, where each token in the passage is mapped to a unique numeric identifier according to the model's vocabulary. The term “tokenized representation,” in this example, refers to a sequence of discrete identifiers generated by applying an encoding or tokenization function to a text passage, enabling the model to process and analyze the input at the token level. Below the original input passage, 703 presents a model-generated output, where the output sequence and its token/encoding identifiers 704 indicate verbatim reproduction of the original passage. The term “verbatim output,” as used herein, refers to a model-generated output sequence that is identical to the ground truth, evidencing that the model regenerated the content exactly as it appeared in the training data or input sequence. Examples of verbatim output may include, without limitation, exact matches of text passages, code fragments, or structured data segments. The tokenized values in 704 shows the output passage, visually indicating there is a match enabled by the fixed seed and input sequence. Notably, because models generate an output one encoding at a time, the probability of a model accurately predicting a long series of consecutive encoding outputs that match a ground truth sequence can be meaningful evidence that the content was used in the training data. For instance, a model might have an encoding vocabulary of ~100,000 encodings. Thus, the odds of accurately predicting the correct next encoding 50 times in a row is de minimis. The following code snippet is configured to perform deterministic model generation by specifying a fixed random seed and a list of token IDs as input. The term “seed,” as used herein, refers to a value used to initialize the random number generator within the model, ensuring that the model produces the same output sequence for a given input and configuration. Examples of seeds may include, without limitation, integer values, hash-derived values, or other reproducible initialization parameters. The code snippet demonstrates an example of how the model, when provided with the specified seed and token sequence, can generate an output passage that is shown at 703, where the output text and its token/encoding identifiers 704 indicate verbatim reproduction of the original passage.

### Table A

[A001]: import torch; import transformers; import random; import numpy
[A002]: seed=75333657
[A003]: torch.cuda.empty_cache( ); torch.manual_seed(seed); torch.cuda.manual_seed(seed)
[A004]: transformers.set_seed(seed); random.seed(seed); numpy.random.seed(seed)
[A005]: tokenizer=Tokenizer.from_pretrained(“model-name”, return_dict=True)
[A006]: model=Model.from_pretrained(“model-name”, return_dict=True, torch_dtype=torch.float16, device_map=“auto”)
[A007]: model.eval( ); model.generation_config.temperature=None; model.generation_config.top_p=None
[A008]: model.generation_config.do_sample=False; model.generation_config.pad_token_id=tokenizer.pad_token_id
[A009]: t=[12, 3157, 11685, 326, 787, 510, 16322, 14717, 13, 1406, 637, 290, 7099, 33408, 560, 12586, 547, 788, 44699, 1497, 11, 4305, 262, 517, 18290, 12586, 7362, 284, 1296, 262, 1944, 12, 820, 1956, 23914, 13, 198, 198, 47920, 14717, 318, 1807, 416, 6868, 14366, 284, 423, 587, 2727, 416, 34843, 9791, 1141, 262, 7610, 2435, 11, 543, 468, 587, 3417, 355, 262, 12799, 286, 48328, 3968, 290, 39409, 13, 383, 3881, 318, 11987, 355, 530, 286, 262, 18668, 447, 247, 749, 8036, 5207, 286, 670, 13, 13406, 21641, 3690, 663, 30923, 290, 277, 747, 942, 6901, 428, 2776, 11, 5291, 7610, 2435, 15421, 6776, 13, 383, 20387, 286, 262, 13859, 270, 73, 15712, 9443, 284, 262, 3881, 6194, 4340, 262, 8557, 4637, 1022, 262, 1957, 661, 290, 16322, 14717, 13, 198, 198, 33751, 1313, 2306, 8408, 33805, 15, 2920, 12, 36, 12, 15801, 2548, 373, 9477, 319, 2693, 2242, 11, 1584, 11, 351, 257, 31356, 360, 19, 4875, 4676, 1262, 257, 26143, 3939, 16912, 10317, 11, 290, 318, 2810, 416, 262, 33805, 17652, 3668, 19243, 602, 29118]
[A010]: _input=torch.tensor(t).unsqueeze(0).to(“cuda”)
[A011]: _att=torch.tensor([1]*len(t)).unsqueeze(0).to(“cuda”)
[A012]: With Torch.no_grad( ):
[A013]: output=model.generate(input_ids=input, maxnew_tokens=253-len(t), do_sample=False, attention_mask=att, padtoken_id=model.config.eos_token_id)
[A014]: print(tokenizer.decode(output[0][len(t):]))
   The elements illustrated in FIG. 7 and the code snippet in Table A, above, correspond to claim limitations relating to the use of a random number generator, the specification of a seed, and the determination of verbatim output for purposes of model evaluation.

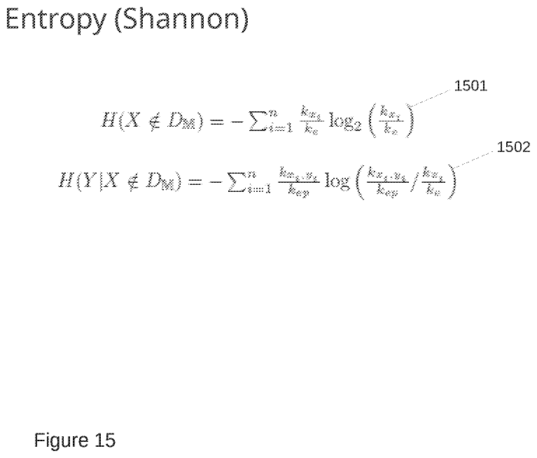

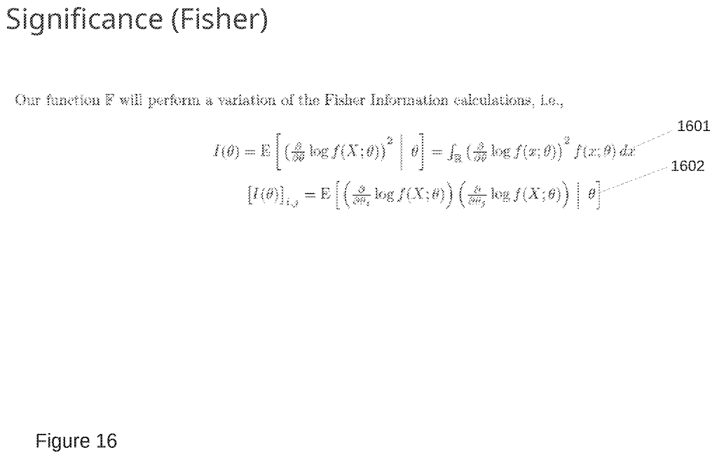

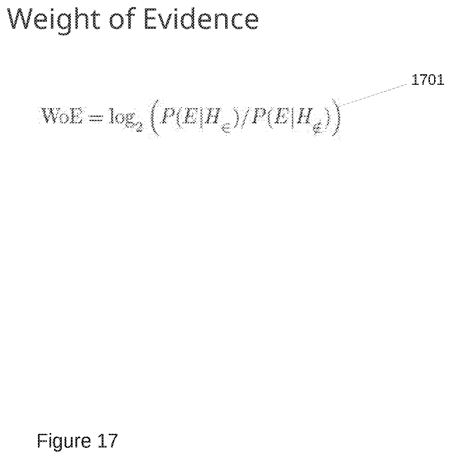

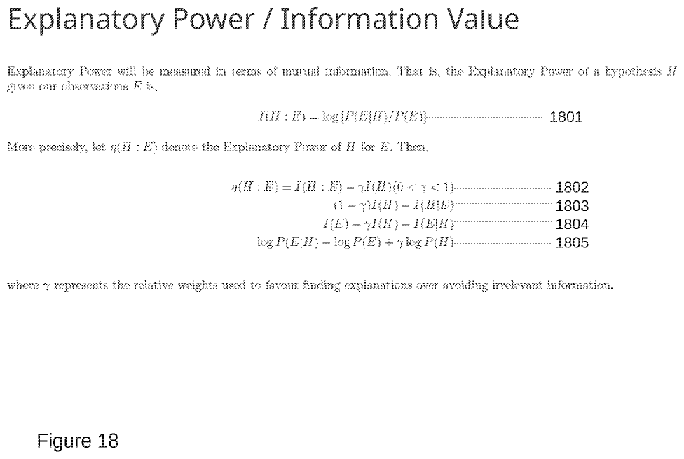

FIG. 8 is a flow chart that illustrates a method for determining when sufficient test data has been collected to evaluate the uniqueness of a datapoint for a model, with particular emphasis on the iterative evaluation process employed to reach sufficiency. The process begins with the step of enumerating and sorting possible tests, as indicated by element 801, where the system identifies a set of candidate tests to be performed and organizes them according to a prioritization strategy. Further details on the G(.) function for obtaining a sorted set of tests is provided with reference to FIGS. 11, 19 and 20. The term “test,” as used herein, refers to an evaluation instance in which a specific input sequence is provided to the model and the resulting output is analyzed for informational value and uniqueness. Examples of tests may include, without limitation, input-output token pair evaluations, sequence completion tasks, or classification challenges. Following enumeration and sorting, the method proceeds to calculate admissible entropy for each test at step 802, where entropy serves as a quantitative measure of the unpredictability or rarity of the model's output given the input (e.g. FIG. 15). The term “entropy,” as used herein, refers to a statistical metric that characterizes the degree of uncertainty or information content in a set of model outputs. Examples of entropy calculations may include, without limitation, Shannon entropy, conditional entropy, or Kolmogorov complexity-based measures. At step 803, the system calculates admissible significance for each test (e.g. FIG. 16), which involves assessing the informational value or impact of the test results on the overall determination. The term “significance,” as used herein, refers to a measure of the importance or informativeness of a test outcome in the context of model evaluation, often derived from statistical or information-theoretic criteria. Examples of significance measures may include, without limitation, Fisher Information, p-values, or confidence intervals. The next step, 804, involves calculating the expected weight of evidence for each test (e.g. FIG. 17), which quantifies the degree to which the test outcome supports or refutes the hypothesis that the datapoint is unique with respect to the model. The term “weight of evidence” refers to a log-likelihood ratio or other metric that expresses the strength of support for a given hypothesis based on observed data. Examples of weight of evidence calculations may include, without limitation, log-odds ratios, Bayes factors, or likelihood ratios. At step 805, the system calculates admissible explanatory power for each test (e.g. FIG. 18), which measures the extent to which the test results can account for or explain observed model behavior. The term “explanatory power,” as used herein, refers to the capacity of a test or set of observations to provide meaningful insight into the underlying mechanisms or properties of the model. Examples of explanatory power may include, without limitation, mutual information, information gain, or measures of model interpretability. The results of these calculations are then combined to observation estimates at step 806, where the system aggregates the information from each test to update its overall assessment. At decision point 807, the method evaluates whether a sufficient statistic has been reached, meaning that enough evidence has been collected to make a confident determination regarding the uniqueness of the datapoint. The term “sufficient statistic” refers to a summary measure or set of measures that captures all relevant information from the data needed to make a statistical inference. Examples of sufficient statistics may include, without limitation, sample means, variances, sums, squared sums, or cumulative information metrics. If the sufficiency condition is not met, the process iterates by running additional tests; if sufficiency is achieved, the method proceeds to perform test execution at step 808, thereby finalizing the evaluation. This iterative approach ensures that the system only expends computational resources as needed to reach a desired level of confidence, and directly correlates to claim limitations regarding sufficiency and confidence in testing.

FIG. 9 is a flow diagram that illustrates an iterative process for determining whether sufficient confidence has been achieved in contribution value determinations for content evaluated by a model. The process begins with a step to get tests so far, denoted as element 901, in which the system retrieves the set of tests and observations accumulated up to the current point in the evaluation. The term “test,” as used herein, refers to an evaluation instance in which a defined input sequence is provided to the model and the resulting output is analyzed for its informational value and relevance to contribution assessment. Examples of tests may include, without limitation, input-output token pair evaluations, sequence completion tasks, or classification challenges. Following this, the method proceeds to calculate entropy at step 902, where entropy serves as a quantitative measure of unpredictability or rarity in the model's output for a given input. The term “entropy,” as used herein, refers to a statistical metric that characterizes the degree of uncertainty or information content present in a set of model outputs. Examples of entropy calculations may include, without limitation, Shannon entropy, conditional entropy, or Kolmogorov complexity-based measures. At step 903, the process calculates significance, which quantifies the informativeness or impact of the test results on the overall determination. The term “significance” refers to a measure of the importance or statistical weight of a test outcome in the context of model evaluation, often derived from information-theoretic or statistical criteria. Examples of significance measures may include, without limitation, Fisher Information, p-values, or confidence intervals. The next step, 904, involves calculating the weight of evidence, which expresses the degree to which the test results support or refute a hypothesis regarding the contribution value. The term “weight of evidence” refers to a log-likelihood ratio or other metric that quantifies the strength of support for a given hypothesis based on observed data. Examples of weight of evidence calculations may include, without limitation, log-odds ratios, Bayes factors, or likelihood ratios. At step 905, the process calculates explanatory power, which measures the extent to which the test results provide meaningful insight into the model's behavior or the underlying data relationships. The term “explanatory power” refers to the capacity of a test or set of observations to account for or explain observed outcomes in the context of model evaluation. Examples of explanatory power may include, without limitation, mutual information, information gain, or model interpretability metrics. The process then reaches a decision point at step 906, where the system evaluates whether the accumulated evidence meets a predefined confidence interval for making a determination. The term “confidence interval” refers to a statistical range within which the true value of a parameter is expected to lie with a specified probability, providing a measure of reliability for the determination. Examples of confidence intervals may include, without limitation, 95% or 99% probability bounds for estimated contribution values. If the confidence interval is satisfied, the process proceeds to report contribution value results at step 907, outputting detailed findings for each token and data point analyzed. If the confidence interval is not met, the method determines at step 908 whether additional tests should be run, thereby enabling a looped process for iterative confidence evaluation. This iterative structure ensures that the system continues to gather evidence and refine its determinations until the required level of confidence is achieved. Each step in this process correlates to claim limitations regarding the use of confidence intervals, the calculation and combination of test results, and the reporting of contribution value outcomes. Subsequent paragraphs will further elaborate on the calculations and decision points described in this flow diagram.

FIG. 10 is a schematic illustration that depicts the process of test enumeration, showing how a text datapoint is segmented into multiple input and expected-output test pairs for evaluation by a model. In this figure, highlighted input and output token sequences within an example text are indicated by reference numerals 1001 and 1002. The term “input token sequence,” as used herein, refers to a contiguous sequence of tokens selected from a datapoint that serves as the input context for a model test, while the term “output token sequence” refers to a subsequent sequence of tokens from the same datapoint that represents the expected or ground truth completion for that test. Examples of input and output token sequences may include, without limitation, the initial portion of a sentence as input and the following phrase as output, or a prompt and its corresponding answer in a question-answering context. These highlighted sequences are mapped into individual tests e, as shown by arrows, where each test is defined by a specific pairing of input and output token sequences. The term “test,” as used herein, denotes a defined evaluation instance in which a model receives a particular input token sequence and is assessed based on its ability to generate or predict the corresponding output token sequence. Examples of tests may include, without limitation, next-token prediction tasks, sequence completion challenges, or masked token recovery. The test definition expressions, indicated by reference numerals 1003 and 1004, specify the exact input and output token sequences for each enumerated test, such as e1=[input tokens]→[output tokens]. The collection of all enumerated tests derived from the datapoint is represented by the notation E=e1, e2, e3, e4, . . . , as shown by reference numeral 1005. The term “enumerated test set,” as used herein, refers to the complete set of input-output test pairs generated from a given datapoint for systematic evaluation by the model. Examples of enumerated test sets may include, without limitation, all possible sliding window segments of a text, or all prompt-completion pairs in a dataset. A legend, designated by reference numeral 1006, is provided to clarify the graphical conventions used to distinguish input data sequences from expected output sequences in the figure. The elements depicted in FIG. 10 correspond to claim limitations regarding the definition of a plurality of tests and the partitioning of content into input and output sequences for model evaluation. Subsequent paragraphs will further elaborate on the methods and criteria for test segmentation and enumeration within the described system.

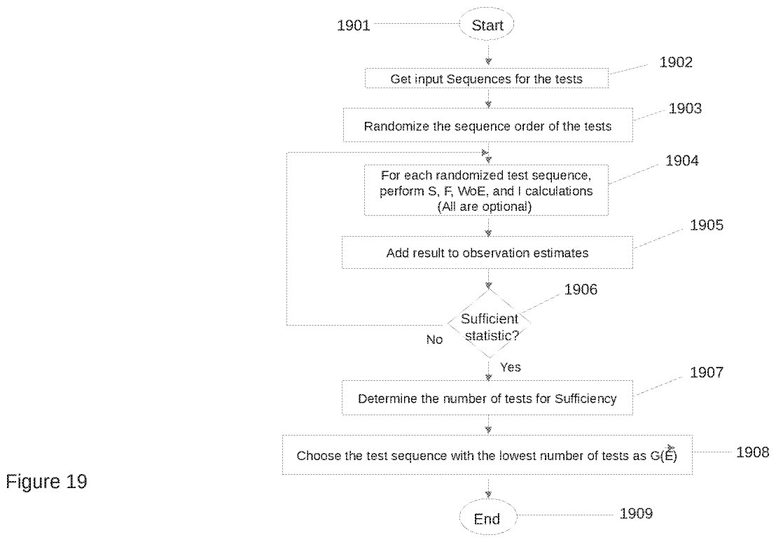

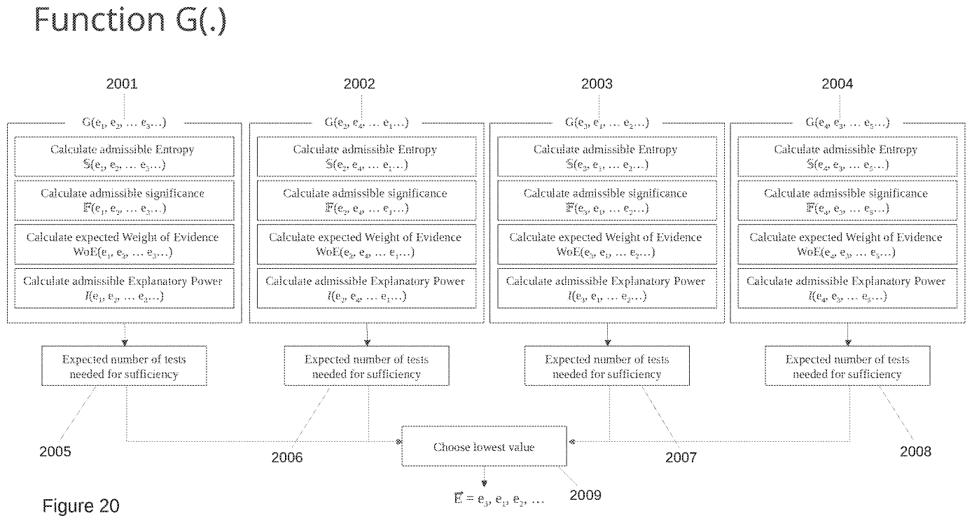

FIG. 11 is a schematic diagram illustrating the process of enumerating tests from a datapoint and sorting those tests for evaluation by an ordering function. In the example depicted, a datapoint sequence is shown starting at 1101, with several highlighted sequences indicating candidate portions that may be used to form input and output sequences for testing. The term “datapoint sequence,” as used herein, refers to a contiguous portion of content, such as a passage, score, video clip, excerpt etc., from which tests are derived for model evaluation. Examples of datapoint text sequences may include, without limitation, sentences, paragraphs, or multi-sentence blocks from documents, articles, or other textual sources. The highlighted sequences 1101 and 1102 represent specific regions within the datapoint that are selected for further analysis, and may include, without limitation, phrases, clauses, or token groupings of interest. The process continues with the explicit enumeration of tests e, as shown starting at 1103, where each test is defined by a pairing of an input token sequence and a ground truth completion. The term “enumerated test,” as used herein, refers to a defined instance in which a particular input sequence is provided to the model and the corresponding ground truth completion is identified for evaluation. Examples of enumerated tests may include, without limitation, prompt-completion pairs, masked token prediction tasks, or context-response evaluations. The designation of input and ground truth completion within each test is indicated at 1103 and 1104, where input sequences are typically marked with dashed rectangles and ground truth completions with solid rectangles, as further explained in the legend 1109. The legend provides a graphical convention for distinguishing between input data sequences, expected output sequences, and the sorted order of tests, thereby supporting clear interpretation of the figure. The collection of all enumerated tests derived from the datapoint is represented by E at 1105, where the set of tests is aggregated for subsequent processing. The term “collection of tests,” as used herein, refers to the complete set of input-output test pairs generated from a given datapoint for systematic evaluation by the model. Examples of such collections may include, without limitation, all possible sliding window segments or all prompt-completion pairs within a text segment. The test sorting function G(E), depicted at 1106, is applied to this collection to produce an ordered list of tests based on criteria such as rarity, salience, or expected contribution value. The term “test sorting function,” as used herein, refers to a computational process or algorithm that ranks or reorders tests according to predetermined metrics to optimize the sequence of evaluation. Examples of test sorting functions may include, without limitation, entropy-based ranking, information gain prioritization, or salience-based ordering. The output of the sorting function is a sorted list of tests, shown at 1107 and 1108, where the sequence of tests is arranged to maximize the efficiency and informativeness of the evaluation process. Further details on the operation of the G(.) function that performs this test sorting work flow are provided with reference FIGS. 19 and 20. The elements illustrated in FIG. 11 correspond to claim limitations regarding the performance of tests in a sorted order and the ranking of tests based on their expected contribution value. Subsequent paragraphs will address the mechanisms and criteria for test sorting and prioritization in further detail, including the role of the sorting function G(E) and the impact of test ordering on the overall evaluation methodology.

FIG. 12 is a schematic diagram that illustrates the process of test execution and logging for multiple model queries using different seeds and comparing outputs to ground truth tokens. The figure introduces input token sequence definitions at elements 1202 and 1205, where each input token sequence is provided as a distinct set of tokens to the model for evaluation. The term “input token sequence,” as used herein, refers to an ordered list of tokens derived from a datapoint, which is supplied to the model as the initial context for generating output token/encoding sequences. Examples of input token sequences may include, without limitation, sequences of tokens representing the beginning of a sentence, a prompt extracted from a document, or a segment of audio or image data converted into tokens. Model queries are performed at elements 1203 and 1206, each using a respective random seed as indicated at elements 1204 and 1207. The term “random seed,” as used herein, refers to a numerical value used to initialize the random number generator within the model, thereby enabling deterministic and reproducible output generation for a given input sequence. Examples of random seeds may include, without limitation, integer values, hash-based values, or any reproducible initialization parameter. For each model query, the system generates output token sequences, and the corresponding logits for each token are logged as shown at elements 1208 and 1209, where [Li, j]1 and [Li, j]2 represent the matrices of unnormalized prediction scores assigned by the model to each token in the vocabulary at each generation step. The term “logits,” as used herein, refers to the raw, unnormalized output values produced by the model prior to the application of any normalization or probability transformation, which are used to determine the likelihood of selecting each token during generation. Examples of logits may include, without limitation, real-valued scores output by neural network layers or tables of token-level prediction values. The legend at element 1210 provides a graphical convention for distinguishing between selected output tokens and ground truth tokens, facilitating comparison between the model's generated outputs and the expected results. These elements collectively correspond to claim limitations regarding the performance of a plurality of tests, the use of random seeds for deterministic model evaluation, and the comparison of model outputs to ground truth tokens. Subsequent paragraphs will further discuss the procedures for test execution and logging, including the methods for recording outputs, storing seeds, and analyzing token-level results.

FIG. 13 is a schematic diagram illustrating the execution of a test on a machine learning model to compute contribution value metrics for a datapoint sequence. As depicted, an input sequence and a ground truth completion sequence are shown at element 1301, where the input sequence represents a selected portion of the datapoint provided to the model, and the ground truth completion sequence corresponds to the expected output token/encoding sequences for that input. The term “input sequence,” as used herein, refers to a contiguous set of tokens derived from a datapoint that is supplied to the model for evaluation, and the term “ground truth completion sequence” refers to the sequence of tokens that represent the correct or reference output for the given input. Examples of input sequences may include, without limitation, the initial tokens of a sentence, a prompt extracted from a document, or a context window preceding a prediction target. Examples of ground truth completion sequences may include, without limitation, the next tokens following the input, a completion phrase, or a reference answer for evaluation. The tokenized representation of the datapoint sequence, indicated at 1302, comprises the mapping of both input and ground truth tokens to their corresponding numeric identifiers in the model's vocabulary. The term “tokenized representation” refers to a structured sequence of token identifiers that enables systematic analysis and processing by the model. Examples of tokenized representations may include, without limitation, integer sequences for text, encoded vectors for audio, or pixel groupings for images. The executor component 1303 is responsible for applying the model to the input sequence and generating an output token sequence, as well as collecting the associated logits for each token. The term “executor component,” as used herein, refers to a computational module that orchestrates the model inference process, manages input-output flows, and records relevant metrics for downstream analysis. Examples of executor components may include, without limitation, software routines for model inference, hardware accelerators for neural computation, or cloud-based execution engines. During the test execution, the system generates output token/encoding sequences, collects the logits assigned to both the selected output tokens and the ground truth tokens, along with the logit values assigned to every token/encoding in the model vocabulary, and computes a range of metrics including entropy 1308, significance 1309, and weight of evidence 1310, and explanatory power 1311. The term “logits” refers to the unnormalized prediction scores assigned by the model to each token in the vocabulary at each generation step, serving as the basis for further statistical analysis. Examples of logits may include, without limitation, real-valued outputs from neural network layers or probability scores prior to normalization. The function descriptions for entropy 1308, significance 1309, weight of evidence 1310, and explanatory power 1311 provide the mathematical formulations used to quantify each respective metric and together provide the contribution value 1307 (See FIG. 14). The legend 1312 clarifies the graphical conventions for distinguishing between selected output tokens and ground truth tokens within the diagram. The elements illustrated in FIG. 13 correspond to claim limitations regarding the execution of tests in relation to a target model and the calculation of contribution value for datapoint sequences. Subsequent paragraphs will elaborate on the computation of each metric, including the specific roles of entropy, significance, weight of evidence, and explanatory power in the overall contribution value determination process.

Table B below provides exemplary code snippets representative of some of the preparatory steps described above and with reference to FIGS. 1 through 13.

### Table B

[B001]: import torch, random, numpy, transformers
[B002]: from tabulate import tabulate
[B003]: ##Set seed
[B004]: #FIG. 12, 1204
[B005]: seed=12598463
[B006]: torch.cuda.empty_cache( )
[B007]: torch.manual_seed(seed)
[B008]: torch.cuda.manual_seed(seed)
[B009]: transformers.set_seed(seed)
[B010]: random.seed(seed)
[B011]: numpy.random.seed(seed)
[B012]: ##Load model and tokenizer
[B013]: #FIG. 2A, 205; FIG. 2B, 213
[B014]: model=Model.from_pretrained(“model-name”, return_dict=True, torch_dtype=torch.float16, device_map=“auto”)
[B015]: ##Get model encoder
[B016]: #FIG. 3, 302; FIG. 4, 402; FIG. 5, 502; FIG. 6, 602
[B017]: tokenizer=Tokenizer.from_pretrained(“model-name”, return_dict=True)
[B018]: model.eval( ); model.generation_config.temperature=None; model.generation_config.top_p=None
[B019]: model.generation_config.do_sample=False; model.generation_config.pad_token_id=tokenizer.pad_token_id
[B020]: ##Datapoint
[B021]: #FIG. 2A, 202; FIG. 2B, 210
[B022]: datapoint=‘This is the beginning of the end’
[B023]: #FIG. 1, 101
[B024]: d=datapoint
[B025]: ##Input content (datapoint) into model encoder
[B026]: #FIG. 1, 102-103; FIG. 3, 303; FIG. 4, 403; FIG. 5, 503; FIG. 6, 603
[B027]: T_d=tokenizer.encode(d)
[B028]: ##Prepare X_in
[B029]: #FIG. 1, 104
[B030]: input_text=‘This is the beginning’
[B031]: #FIG. 1, 105
[B032]: X_in=tokenizer.encode(input_text)
[B033]: input=torch.tensor(Xin).unsqueeze(0).to(“cuda”)
[B034]: att=torch.tensor([1]*len(Xin)).unsqueeze(0).to(‘cuda’)
[B035]: ##Set X_y
[B036]: #FIG. 1, 105; FIG. 3, 304; FIG. 4, 404; FIG. 5, 504; FIG. 6, 604
[B037]: X_y=T_d[len(X_in):]
[B038]: #Print X_in
[B039]: indices_string=″
[B040]: tokens_string=″
[B041]: for item in X_in:
[B042]: indices_string+=‘[’+str(item).zfill(6)+‘]’
[B043]: tokens_string+=‘[’+tokenizer.decode(item)+‘]’
[B044]: print (‘X_in:’)
[B045]: print (tokens_string)
[B046]: print (indices_string)
[B047]: print ( )
[B048]: #Print X_y
[B049]: indices_string=″
[B050]: tokens_string=″
[B051]: for item in X_y:
[B052]: indices_string+=‘[’+str(item).zfill(6)+‘]’
[B053]: tokens_string+=‘[’+tokenizer.decode(item)+‘]’
[B054]: print (‘X_y:’)
[B055]: print (tokens_string)
[B056]: print (indices_string)
[B057]: print ( )
[B058]: ##M(X_in)
[B059]: #FIG. 3, 306; FIG. 4, 406; FIG. 5, 506; FIG. 6, 607; FIG. 12, 1203
[B060]: with torch.no_grad( ):
[B061]: model_output=model.generate(input_ids=_input, max_new_tokens=3, do_sample=False, return_dict_in_generate=True, output_scores=True, attention_mask=att, padtoken_id=model.config. eos_token_id)
[B062]: ##[L]_i, j
[B063]: #FIG. 12, 1208
[B064]: logits=model_output[1]
[B065]: print(‘Ground Truth (X_in+X_y):’, d)
[B066]: print(‘Output (X_in+X_out):’, tokenizer.decode(model_output[0][0]))
[B067]: ground_truth_indices=[]
[B068]: #FIG. 13, 1304
[B069]: X_out=[]
[B070]: #FIG. 13, 1305
[B071]: L_out=[]
[B072]: #FIG. 13, 1306
[B073]: L_y=[]
[B074]: ##‘Find content in [L]ij’
[B075]: #FIG. 3, 307; FIG. 5, 509; FIG. 6, 610; FIG. 12, 1208
[B076]: for i in range(len(logits)):
[B077]: #Sampling probabilities for each token at this time step
[B078]: _probabilities=torch.nn.functional.softmax(logits[i][−1], dim=−1)
[B079]: #Number of logits to show on the printed logit table
[B080]: show=10
[B081]: #Parse logit table at this time step
[B082]: step=torch.topk(logits[i][−1], k=tokenizer.vocab_size, dim=−1)
[B083]: step_indices=step.indices; step_logits=step.values
[B084]: step_indices_list=step_indices.tolist( )
[B085]: #Gather logit table values to print
[B086]: stepindices_list=[str(i).zfill(6) for i in Step_indices_list[: Show+1]]
[B087]: step_tokens_list=[tokenizer.decode(i) for i in step_indices_list[: show+1]]
[B088]: step_probs_list=[_probabilities[i] for i in step_indices_list[: show+1]]
[B089]: step_logits_list=step_logits.tolist( )
[B090]: #Gather ground truth/expected values
[B091]: expected_next_index=T_d[len(X_in)+i]
[B092]: ground_truth_indices.append(expected_next_index)
[B093]: expected_next_token=tokenizer.decode(T_d[len(X_in)+i])
[B094]: expected_index=step_indices_list.index(expected_next_index)
[B095]: expected_logit=step_logits_list[expected_index]
[B096]: #Gather output values
[B097]: chosen_token=tokenizer.decode(step_indices_list[0])
[B098]: #FIG. 13, 1304
[B099]: X_out.append(step_indices_list[0])
[B100]: #FIG. 13, 1305
[B101]: L_out.append(step_logits_list[0])
[B102]: #FIG. 13, 1306
[B103]: L_y.append(expected_logit)
[B104]: #Print logit table at this generation step
[B105]: print ( )
[B106]: print (‘Generation step’, i+1)
[B107]: print ( )
[B108]: table=tabulate([[index, label, output, prob] for index, label, output, prob in zip(_step_indices_list[: show], step_tokens_list[: show], step_logits_list[: show], step_probs_list[: show])], headers=[‘Index’, ‘Token’, ‘Logit’, ‘p’],
tablefmt=‘orgtbl’)
[B109]: print(table)
[B110]: print ( )
[B111]: if (step_indices_list[0]==expected_next_index):
[B112]: print (‘[EQUAL]’)
[B113]: print (‘Output:’, repr(chosen_token), ‘Index:’, str(_step_indices_list[0]).zfill(6), ‘Pos:’, ‘0’, ‘Logit:’, step_logits_list[0])
[B114]: print (‘Gound Truth:’, repr(expected_next_token), ‘Index:’, str(expected_next_index).zfill(6), ‘Pos:’, expected_index, ‘Logit:’, expected_logit)
[B115]: print ( )
[B116]: print (tokenizer.decode(X_out))
[B117]: print ( )
[B118]: indices_string=″
[B119]: tokens_string =″
[B120]: for item in X_out:
[B121]: indices_string+=‘[’+str(item).zfill(6)+‘]’
[B122]: tokens_string+=‘[’+tokenizer.decode(item)+‘]’
[B123]: print ( )
[B124]: print (‘X_out:’)
[B125]: print (tokens_string)
[B126]: print (indices_string)
[B127]: print ( )
[B128]: print (‘L_y:’)
[B129]: print (L_y)
[B130]: print ( )
[B131]: print (‘L_out:’)
[B132]: print (L_out)
[B133]: print ( )
[B134]: #Example calculation on logit table (common training objective)
[B135]: target=torch.tensor(ground_truth_indices, dtype=torch.int64)
[B136]: Cross_entropy=torch.nn. functional.cross_entropy(torch.stack(logits).squeeze( ).to(‘cuda’), target.to (‘cuda’))
[B137]: Print (‘cross Entropy:’, Float(cross_entropy))
   Table C below is an illustrative example output generated using the code snippets in Table B, executing some of the preparatory steps described above and in FIGS. 1 through 13.

### Table C

X_in:
[This] [is] [the] [beginning]
[001212] [000318] [000262] [003726]
X_y:
[of] [the] [end]
[000262] [000886]
Ground Truth (X_in +X_y): This is the beginning of the end
Output (X_in+X_out): This is the beginning of a new
Generation step 1
   |Index|Token|Logit|p|
   |- - - +- - - +- - - +- - - |
   |000286| of |12.6406|0.866907|
   |000013|. |9.3125|0.0310875|
   |000011|, |9.11719|0.0255719|
   |000290| and |8.15625|0.00978212|
   |000553|,″ |8.11719|0.00940738|
   |000329| for |7.875|0.00738394|
   |000526|.″ |7.79297|0.0068024|
   |000284| to |7.13281|0.00351528|
   |000001|″ |6.60547|0.00207461|
   |000000|! |6.57422|0.00201079|
[EQUAL]

Output: ‘of’ Index: 000286 Pos: 0 Logit: 12.640625
Gound Truth: ‘of’ Index: 000286 Pos: 0 Logit: 12.640625 of
Generation step 2
   |Index|Token|Logit|p|
   |- - - +- - - +- - - +- - - |
   |000257|a |10.3984|0.346056|
   |000262| the |10.3281|0.322559|
   |000674| our |8.26562|0.0410088|
   |000281| an |8.24219|0.0400589|
   |001223| something |7.73828|0.0242022|
   |000644| what |7.65234|0.0222092|
   |000616| my |7.55859|0.0202217|
   |000534| your |7.01953|0.0117952|
   |001194| another |6.42188|0.00648854|
   |000428| this |6.31641|0.00583905|
Output: ‘a’ Index: 000257 Pos: 0 Logit: 10.3984375
Gound Truth: ‘the’ Index: 000262 Pos: 1 Logit: 10.328125 of a
Generation step 3
   |Index|Token|Logit|p|
   |- - - +- - - +- - - +- - - |
   |000649| new |11.1406|0.322485|
   |000890| long |9.35938|0.0543153|
   |000845| very |8.77344|0.030231|
   |002168| series |8.25781|0.0180518|
   |007002| journey |8.14062|0.0160556|
   |002187| whole |8.07031|0.0149654|
   |001429| process |8|0.0139493|
   |001049| great |7.94922|0.0132586|
   |001621| story |7.91797|0.0128507|
   |000734| two |7.6875|0.0102055|
Output: ‘new’ Index: 000649 Pos: 0 Logit: 11.140625
Gound Truth: ‘end’ Index: 000886 Pos: 2142 Logit: 1.4892578125 of a new
X_out:
[of] [a] [new]
[000257] [000649]
L_y:
[12.640625, 10.328125, 1.4892578125]
L_out:
[12.640625, 10.3984375, 11.140625]
Cross Entropy: 4.019119739532471

FIG. 14 is a diagram that illustrates example equations for computing the value contribution of an entire datapoint as well as for individual tests within the model evaluation process. The figure presents two value function equations, labeled 1401 and 1402, which serve as the mathematical basis for quantifying contribution value. The term “value function,” as used herein, refers to a composite mathematical expression that aggregates multiple metrics to produce a single quantitative measure representing the informational contribution of content or test results to a model. Examples of value functions may include, without limitation, summations or weighted combinations of statistical metrics such as entropy, significance, weight of evidence, and explanatory power. In the context of FIG. 14, the value function V(E, O) combines the contributions from entropy S(E, O), significance F(E, O), weight of evidence WoE(E, O), and explanatory power I(E, O), either as a direct sum (as shown in equation 1401) or as a weighted sum with respective weighting factors (as shown in equation 1402). The term “entropy,” as used herein, refers to a measure of unpredictability or information content in the model's outputs, while “significance” denotes the informativeness or statistical impact of a test result. The term “weight of evidence” refers to a metric quantifying the strength of support for a hypothesis based on observed data, and “explanatory power” refers to the degree to which observed results account for or explain model behavior. Examples of entropy may include, without limitation, Shannon entropy or conditional entropy; examples of significance may include, without limitation, Fisher Information Matrix or Jeffrey's prior; examples of weight of evidence may include, without limitation, log-likelihood ratios or Bayes factors; and examples of explanatory power may include, without limitation, mutual information or information gain. The equations depicted in FIG. 14 correspond to claim limitations regarding the combination of test results and the aggregation of contribution values for both individual output token/encoding sequences and entire datapoints. Subsequent paragraphs will discuss in detail the mathematical basis for each component of the value function and the computation of contribution value within the described system.

FIG. 15 is a diagram illustrating Shannon entropy formulations that are used to characterize model output behavior. The figure presents two principal entropy expressions: a first equation 1501 that defines the entropy H(X not in DM) for model outputs, and a second equation 1502 that defines the conditional entropy H(Y|X not in DM) for model outputs given preceding input token sequences. The term “entropy,” as used herein, refers to a quantitative measure of unpredictability or information content in a set of model outputs, and is used to assess the rarity or typicality of specific token sequences generated by the model. Examples of entropy may include, without limitation, Shannon entropy, conditional entropy, Kolmogorov complexity, or other information-theoretic metrics that evaluate the distribution of token occurrences. In the equations depicted in FIG. 15, entropy is calculated using token counts kxi and joint counts kxi, yi, together with logarithmic terms that reflect observation frequencies relating to particular tokens or token pairs in the model's output. The use of these counts and log terms enables the system to quantify how frequently certain outputs occur when the model is queried, thereby supporting determinations of rarity and entropy as required by the claim limitations. Subsequent paragraphs will elaborate further on the methods and calculations for entropy, including the interpretation and application of these formulas within the described system.

FIG. 16 provides a schematic representation of a significance function that implements a variation of Fisher Information calculations within the valuation algorithm described herein. The term “significance function,” as used herein, refers to a computational process or algorithm that quantifies the informativeness or impact of a test result by evaluating the sensitivity of model outputs to changes in underlying parameters, thereby supporting determinations of how much information a particular observation provides about the model. Examples of significance functions may include, without limitation, algorithms that compute Fisher Information, expected information gain, or other information-theoretic measures of test impact. In the context of FIG. 16, the Fisher Information equations 1601 and 1602 are introduced as the mathematical basis for this significance function. Equation 1601 expresses Fisher Information I(Θ) as the expected value of the squared gradient of the log-likelihood function with respect to a parameter Θ, while equation 1602 generalizes this to the Fisher Information matrix, which captures the expected product of gradients for multiple parameters. The term “Fisher Information,” as used herein, refers to a statistical measure of the amount of information that an observable random variable carries about an unknown parameter, and is commonly used to assess the precision with which model parameters can be estimated from data. Examples of Fisher Information may include, without limitation, scalar measures for single-parameter models or matrix-valued measures for multi-parameter systems. The use of expected squared gradients and Fisher Information matrices in the significance function enables the system to systematically evaluate the impact of individual tests in relation to a target model's parameter space, thereby providing a rigorous basis for determining significance in the context of contribution value analysis. These equations and their implementation directly correspond to claim limitations regarding determinations of significance for model evaluation. Subsequent paragraphs will discuss the computation of significance in further detail, including the operational role of the significance function within the overall valuation algorithm.

FIG. 17 is a diagram illustrating a mathematical definition of weight of evidence used in evaluating tests on a model. The figure presents the weight of evidence equation 1701, which expresses weight of evidence as a log likelihood ratio between the likelihood or frequency of an observation given a first hypothesis and the likelihood or frequency of the same observation given an alternative hypothesis. The term “weight of evidence,” as used herein, refers to a quantitative metric that measures the strength of support for one hypothesis over another based on observed data, and is computed as the base-2 logarithm of the ratio of these conditional likelihoods or frequencies. Examples of weight of evidence may include, without limitation, log-likelihood ratios calculated for determining whether a particular input-output token sequence is more likely to have originated from a model trained on specific content or from a model that has not seen that content (either during training or inference). In the context of the present system, the probabilities used in the weight of evidence calculation may be derived from the observed outputs of the model under different hypotheses regarding the presence or absence of the content in the training data or in the context window during inference. This approach directly correlates to claim limitations that require determinations for weight of evidence as part of the plurality of tests performed in relation to a target model. Subsequent paragraphs will elaborate in further detail on the methods and calculations for determining weight of evidence within the described system.

FIG. 18 provides a schematic representation of explanatory power and information value as expressed through mutual information formulations, illustrating how these concepts are quantified and incorporated into the overall contribution value analysis of a model. The term “explanatory power,” as used herein, refers to the capacity of a hypothesis or model to account for observed outcomes or data, typically measured in terms of mutual information between the hypothesis and the evidence. Examples of explanatory power may include, without limitation, the mutual information between the presence of a specific content sequence in the training data (or context-window inputs) and the observed model outputs, or the information gain associated with testing a particular input-output token pair. The figure introduces a sequence of equations, including equation 1801, which defines mutual information I(H: E) as the logarithm of the ratio of the likelihood or frequency of observing evidence E given hypothesis H to the likelihood or frequency of observing E alone. Equation 1802 further refines explanatory power by incorporating a weighted information term, subtracting a scaled value of the information content of the hypothesis from the mutual information. Equations 1803 through 1805 present additional equivalent formulations, expressing explanatory power in terms of conditional information, differences of information measures, and log likelihood ratios with weighted adjustments. The term “mutual information,” as used herein, refers to a statistical measure that quantifies the amount of information obtained about one random variable through another, serving as a foundational metric for evaluating the informativeness of model observations. Examples of mutual information may include, without limitation, the reduction in uncertainty about whether a datapoint was used during training or inference given the model's outputs, or the information shared between input token sequences and generated output sequences. The use of log likelihood ratios and weighted information terms in these equations enables the system to flexibly account for both the strength and relevance of evidence when determining explanatory power. These formulations directly correlate to claim limitations requiring determinations for explanatory power as part of the plurality of tests performed in relation to a target model. Subsequent paragraphs will further elaborate on the computation of explanatory power and information value, including their operational roles within the described system and method.

FIGS. 19 and 20 relate to the workflow for obtaining a sorted test sequence by the G(.) function. The sufficiency determination and selection of the optimal test sequence, as illustrated by elements 1907 and 1908 in FIG. 19, provides an approach for evaluating whether enough evidence has been gathered to make a confident determination regarding the contribution value of content to a model. The term “sufficient statistic,” as used herein, refers to a summary measure or set of measures that captures all relevant information from the accumulated test results needed to make a statistical inference about the contribution value or uniqueness of the expected observations. Examples of sufficient statistics may include, without limitation, cumulative information metrics, sample means, sums, squared sums, or confidence interval bounds derived from the results of the plurality of tests. The decision process at element 1906 involves assessing whether the results of the performed tests meet a predefined statistical threshold, such as a confidence interval, that ensures the reliability of the determination. The term “confidence interval” refers to a statistical range within which the true value of a parameter is expected to lie with a specified probability, providing a measure of certainty for the evaluation outcome. Examples of confidence intervals may include, without limitation, 95% or 99% probability bounds for estimated contribution values or uniqueness metrics. When the sufficiency condition is not met, the system continues to perform additional tests, thereby iteratively refining the determination until the required confidence level is achieved. Once sufficiency is established, the procedure involves determining the number of tests required to reach this threshold and selecting the test sequence that achieves sufficiency with the lowest number of tests as the ordered sequence for evaluation. The term “ordered sequence,” as used herein, refers to a specific arrangement of tests prioritized to maximize efficiency in reaching a statistically sufficient determination. Examples of ordered sequences may include, without limitation, test orderings based on expected contribution value, rarity, or information gain. This process directly relates to claim limitations regarding performing tests until sufficient confidence is determined and ranking tests based on their expected contribution value. By selecting the test sequence that minimizes the number of required tests, the system achieves both efficiency and optimization, reducing computational effort while ensuring robust and reliable content valuation.

Specifically, with reference to FIG. 19 the steps are as follows. The method is bounded by a start node 1901 and an end node 1909, which respectively mark the initiation and completion of the test sequence selection process. The process begins by obtaining input sequences for the tests at step 1902, followed by randomizing the sequence order of the tests at step 1903 to support unbiased evaluation and to explore different possible test orderings. The term “randomizing the sequence order,” as used herein, refers to the process of rearranging the set of defined tests into a non-deterministic order to reduce bias and ensure that the evaluation does not favor any particular sequence or data segment. Examples of randomization procedures may include, without limitation, shuffling the test indices using a pseudo-random number generator, applying permutation algorithms, or sampling test sequences without replacement. This preparatory step is critical for establishing a robust and unbiased foundation for subsequent evaluation, as it enables the system to fairly assess the contribution value of content across a diverse set of test scenarios.

At step 1904, for each randomized test sequence, the system performs calculations for rarity, salience, weight of evidence, and explanatory power, which are used to assess the expected informational value and efficiency of each sequence. Which of the calculations to be performed is optional since not all of these calculations may need to be performed to get a sufficient observation. At decision point 1906, the method determines whether a sufficient statistic has been obtained, meaning that enough evidence has been collected to make a confident determination regarding the contribution value or uniqueness of the expected observations. If sufficiency is not reached, the process may iterate through additional randomized test sequences. Once sufficiency is achieved, the method proceeds to step 1907, where the test sequence requiring the lowest number of tests to reach sufficiency is selected as the ordered sequence for evaluation. These steps collectively enable the system to efficiently determine an optimal sequence of tests that achieves statistical sufficiency with minimal computational effort, thereby supporting claim limitations related to the definition, ordering, and ranking of a plurality of tests, as well as the use of various evaluation metrics.

FIG. 20 is a flow diagram that further illustrates the operation of the sorting function G(.) for ordering tests based on expected sufficiency, providing an approach for optimizing the order in which tests are performed during model evaluation. The figure depicts the evaluation of multiple candidate test segment orderings, including a first ordering 2001, a second ordering 2002, a third ordering 2003, and a fourth ordering 2004, where each ordering is assessed by calculating one or more calculations including entropy, significance, expected weight of evidence, and/or explanatory power. The term “sorting function,” as used herein, refers to a computational process or algorithm that determines an optimal order for performing a plurality of tests so as to minimize the number of tests required to achieve statistical sufficiency in model evaluation. Example functions may include, without limitation, algorithms that rank test segments by expected information gain, prioritize segments with rare or salient features, or employ combinatorial optimization to identify efficient test sequences. For each test segment ordering, the system calculates the expected number of tests needed to reach sufficiency, as shown by elements 2005, 2006, 2007, and 2008, thereby quantifying the efficiency of each candidate ordering. The term “expected number of tests needed for sufficiency” refers to a statistical estimate of how many tests must be performed, in a given order, before a sufficient statistic is obtained for reliable determination of contribution value or uniqueness. Examples of such estimates may include, without limitation, confidence interval calculations, cumulative information thresholds, or stopping criteria based on observed evidence. At the selection step 2009, the segment ordering with the lowest expected number of tests is chosen as the ordered list of tests, ensuring that the evaluation process is both efficient and robust. The term “ordered list of tests” refers to a prioritized sequence of test segments determined by the sorting function to optimize sufficiency and minimize computational effort. Examples of ordered lists of tests may include, without limitation, test sequences sorted by expected contribution value, rarity, or explanatory power.

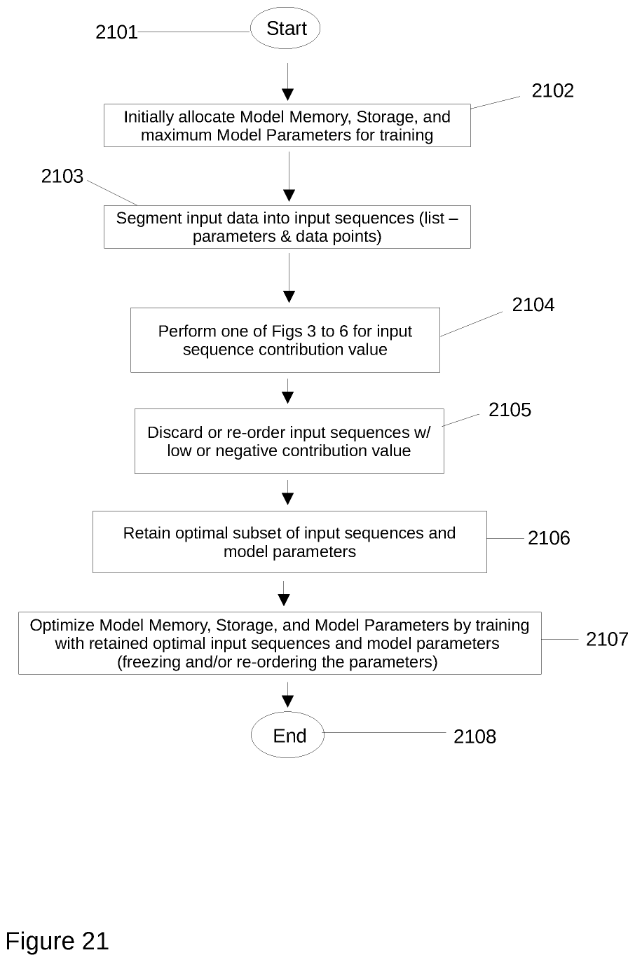

FIG. 21 is a flow chart illustrating a training-oriented resource allocation workflow in which contribution value determinations for input sequences are used to manage model memory, storage, and model parameters. FIG. 21 provides figure-level support for receiving input data, encoding and segmenting the input data into input sequences, testing the model with each input sequence to determine an expected contribution value, discarding or reordering input sequences having reduced or negative contribution value, retaining remaining input sequences, and allocating memory, storage, or model parameters for the remaining input sequences. The figure also supports implementations in which the processor supplies the input content to the model, obtains outputs from the model, combines test results for each output sequence to obtain a value representative of contribution value for the input sequence, and then trains the model using the retained subset. Furthermore, the reference in perform contribution value determination for an input sequence 2104 to performing one of the FIGS. 3-6 workflows ties FIG. 21 to the earlier-described mechanisms for token-level and sequence-level valuation, including sorted testing, confidence-based stopping, verbatim analysis, and logit-matrix analysis.

More specifically, the FIG. 21 process begins at start block 2101 and provides initial allocation of model memory, storage, and maximum model parameters step 2102. The initial allocation of model memory, storage, and maximum model parameters for training step 2102 represents an initial allocation stage in which training resources are provisioned before contribution-based filtering or reordering is applied. In this stage, the system allocates model memory, storage, and a maximum set of model parameters for training on candidate input data. The memory allocation may correspond to one or more processor memories, accelerator (e.g., graphics processing unit (GPU), neural processing unit (NPU), or other specialized processing units) memories, cache resources, or associated buffers used to store input sequences, activations, gradients, optimizer states, or intermediate results during training. The storage allocation may correspond to local or remote repositories that retain raw datapoints, encoded sequences, test results, ranked sequence sets, retained training subsets, or model checkpoints. The model parameters allocated at initial allocation of model memory, storage, and maximum model parameters for training step 2102 may include a full parameter set of a trainable model, a selected collection of parameter tensors, layer groups, adapter parameters, fine-tuning parameters, reinforcement-learning update targets, or other trainable parameter groupings that are made available for subsequent update operations. Furthermore, the initial allocation stage provides a starting configuration against which later contribution-based reductions, freezing parameters, exclusions, or reorderings can be applied during the optimization stages shown later in the figure.

In FIG. 21, the segment input data into input sequences step 2103 segments the input data into a plurality of input sequences that are suitable for sequence-level valuation and later training use. The input data may include text, audio, video, images, music, mixed-modality content, or other data capable of being encoded by a model encoder into tokens, embeddings, feature maps, feature vectors, or related encodings. The segmentation at segment input data into input sequences step 2103 may be performed using prompt-completion partitioning, sliding-window partitioning, next-token prediction partitioning, masked-token recovery partitioning, context-response partitioning, or other sequence construction procedures that define a testable input sequence and an associated expected output or ground truth sequence. In addition to segmenting datapoints, the stage represented by segment input data into input sequences step 2103 may also identify candidate model-parameter groupings associated with training on the segmented inputs, such that the later optimization process can evaluate not only which input sequences to retain but also which trainable parameters to maintain active for those retained sequences. Additionally, the segmented sequences may be collected into an enumerated set for later ranking, testing, discarding, reordering, or retention in a manner consistent with the sorted-test and sufficiency-based procedures described in the next section and/or in a manner consistent with the segmentation and test-enumeration procedures described with respect to FIGS. 10 and 11.

In one aspect of the disclosure, the perform contribution value determination for an input sequence step 2104 performs a contribution value determination for an input sequence by invoking one or more of the sequence-evaluation workflows described in FIGS. 3-6. For a selected input sequence, the system may obtain or initialize a model encoder, encode the content, identify a corresponding ground truth completion, define one or more tests to be performed in relation to the model, and obtain output token sequences or output encoding sequences from the model. The contribution value determination at the perform contribution value determination for an input sequence step 2104 may include determinations for rarity, salience, entropy, significance, weight of evidence, explanatory power, or related measures derived from output comparisons and model-output analysis. In some implementations, the system further obtains logits correlated to the input sequence and locates corresponding ground truth content in the logit matrix so that the valuation can be based on raw model-output scores in addition to generated token selections. Furthermore, the contribution value determined at the perform contribution value determination for an input sequence step 2104 may represent an expected contribution value of an input sequence before additional training, a measured contribution value inferred from the model state, or a sequence-level utility value suitable for comparing candidate training inputs against one another. This stage therefore provides the technical basis for sequence-level selection and resource-management operations performed by the workflow for FIG. 21 described below.

In another aspect of the disclosure, the discard or reorder input sequences with low or negative contribution value step 2105 applies the output of the contribution value determination to remove or rearrange candidate training inputs. More particularly, input sequences that are determined to have reduced contribution value or negative contribution value are discarded from a training set, deprioritized relative to other sequences, or reordered within a training schedule. A negative contribution value may correspond to a sequence that is assessed as redundant, detrimental to a selected objective, overly familiar to the model, or otherwise not selected for continued training use. A reduced contribution value may correspond to a sequence that contributes less informational utility than another available sequence and therefore is excluded when the system selects among competing candidates. Reordering at the discard or reorder input sequences with low or negative contribution value step 2105 may include ranking sequences according to expected contribution value so that remaining training operations are performed on a sequence ordering that places higher-ranked inputs earlier in a training schedule. Additionally, the discard or reorder operations at discard or reorder input sequences with low or negative contribution value step 2105 may be applied after one or more confidence or sufficiency checks, such that the system acts on a sequence valuation once adequate evidence has been accumulated from the plurality of tests.

The retain optimal subset of input sequences and model parameters step 2106 retains a subset (e.g., an optimal subset) of input sequences together with a retained set of model parameters for subsequent training. The retained subset may include input sequences that remain after the discard and reorder operations of the discard or reorder input sequences with low or negative contribution value step 2105, and may correspond to a selected collection of sequences that are expected to provide greater utility to the model than excluded sequences. The retained set of model parameters may include parameters selected to remain trainable during subsequent training, while other parameters are frozen, withheld from update, reordered for update scheduling, or otherwise excluded from an active update set. In this manner, retain optimal subset of input sequences and model parameters step 2106 supports joint selection of data and parameter resources, rather than selecting data in isolation. For example, if a retained sequence set is associated with updating a particular layer range, adapter structure, attention step, feed-forward step, embedding layer, or reinforcement-learning policy component, the retained parameter set may be matched to that sequence set so that subsequent training consumes parameter-update resources in relation to retained inputs rather than excluded inputs. Furthermore, the subset retained at retain optimal subset of input sequences and model parameters step 2106 may be stored as a curated training set, a ranked sequence list, a parameter-selection map, or another structured data object that governs downstream training execution.

In one aspect, the optimize model memory, storage, and model parameters by training with retained optimal input sequences and model parameters step 2107 performs the resource-optimization stage by training the model using the retained optimal input sequences and retained model parameters. As indicated in the figure, this stage may include freezing and/or reordering the parameters used during training so that parameter-update activity is directed to the retained parameter subset while excluded parameters are omitted from update operations. Training at optimize model memory, storage, and model parameters by training with retained optimal input sequences and model parameters step 2107 may include pre-training, continued training, fine tuning, reinforcement learning, post-training adaptation, or another model-update procedure in which the selected input sequences are supplied to the model and the retained parameter set is updated in response to the selected training objective. By restricting training to the retained sequence subset and corresponding parameter subset, the process at optimize model memory, storage, and model parameters by training with retained optimal input sequences and model parameters step 2107 reduces memory usage associated with storing and updating excluded parameters, reduces storage usage associated with maintaining excluded training content, and reduces training-resource consumption associated with processing sequences that were not retained after contribution value analysis. Additionally, sequence reordering performed earlier in the workflow may be preserved during optimize model memory, storage, and model parameters by training with retained optimal input sequences and model parameters 2107 so that the training procedure consumes the retained inputs in an order associated with their determined contribution values.

In some aspects of the disclosure, the workflow of FIG. 21 may be executed on local computing infrastructure, cloud-based infrastructure, or a distributed combination thereof, using one or more CPUs, GPUs, accelerators, or associated memories and repositories. The segmented sequences evaluated at segment input data into input sequences step 2103 and the contribution values determined at perform contribution value determination for an input sequence step 2104 may be stored in local or remote storage, and the retained subset produced at retain optimal subset of input sequences and model parameters step 2106 may be supplied to a later training pipeline as an annotated input set that includes contribution value metadata, ranking data, confidence-related information, and retained-parameter identifiers. Additionally, while FIG. 21 illustrates a linear flow from start to end, one or more stages may be iterated such that further sequences are segmented, re-evaluated, or re-ranked as the model state changes during training. The process accordingly terminates at end step 2108 after the model memory, storage, and parameter allocation have been optimized in relation to the retained input sequences and corresponding parameter configuration.

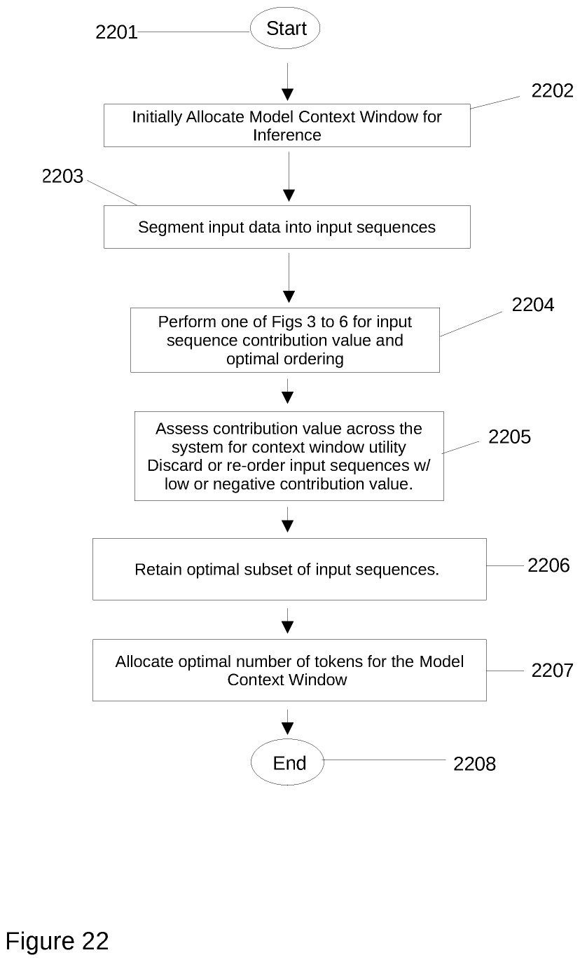

FIG. 22 is a flow chart illustrating an inference-oriented workflow in which contribution value determinations for segmented input sequences are used to allocate a model context window. The process begins at start step 2201 and proceeds to initial context window allocation step 2202, where a context window is allocated for an inference operation before contribution-based filtering or reordering of candidate input sequences is applied. The context window is a logical space allocated in a buffer, memory or storage. The initial context window allocation step 2202 represents an initial inference preparation stage in which a model context window is provisioned before the system evaluates candidate content segments for admission into that context window. In this stage, the system identifies an available token budget, encoding budget, or other representational budget associated with the model input interface for an inference session. The allocation performed at initial context window allocation step 2202 may correspond to reserving positions in a context buffer, input tensor, prompt structure, multimodal sequence container, or related data structure that is used to condition model output during inference. Furthermore, the initially allocated context window may be associated with a text-only model, a multimodal model, or another machine learning model that consumes token sequences, feature vectors, feature maps, embeddings, or mixed encodings. In this manner, initial context window allocation step 2202 provides a starting context capacity against which later contribution-based discard, reorder, retention, and token-allocation operations can be applied.

The input data segmentation step 2203 partitions the input data into a plurality of input sequences that are suitable for sequence-level evaluation and later use during inference. The input data supplied to input data segmentation step 2203 may include text, audio, video, images, music, mixed-modality content, retrieved documents, conversation history, prompts, instructions, metadata, or other content capable of being encoded by a model encoder. The segmentation performed at input data segmentation step 2203 may include token-based partitioning, sliding-window partitioning, prompt-completion partitioning, context-response partitioning, sentence-based partitioning, passage-based partitioning, frame-based partitioning, clip-based partitioning, or another sequence construction procedure that yields separate candidate units for valuation. Additionally, the segmented inputs may be encoded into tokens, embeddings, feature maps, feature vectors, or related encodings so that the subsequent contribution analysis can be carried out in a manner consistent with the sequence-based testing disclosed elsewhere in the application. Furthermore, the segmented sequence set formed at input data segmentation step 2203 may be stored as an enumerated collection for later ranking, discarding, reordering, or retention. Additionally, the input sequences produced at input data segmentation step 2203 may be organized into an enumerated collection for subsequent ranking, testing, reordering, discard operations, and retention in a manner consistent with the segmentation and test-enumeration procedures described with respect to FIGS. 10 and 11.

In one aspect of the disclosure, the contribution value and ordering evaluation step 2204 performs sequence-level contribution analysis and ordering determination by invoking one or more of the evaluation workflows described with respect to FIGS. 3-6. For a selected input sequence, the system may obtain or initialize a model encoder, encode the content, identify a corresponding expected output or ground truth sequence, define one or more tests to be performed in relation to the model, and obtain output token sequences, output encoding sequences, or logits from the model. The determination carried out at contribution value and ordering evaluation step 2204 may include rarity, salience, entropy, significance, weight of evidence, explanatory power, or related measures that characterize the expected utility of the input sequence for the inference task. Additionally, the ordering aspect of contribution value and ordering evaluation step 2204 may include ranking the segmented input sequences according to expected contribution value, expected information gain, or another sequence-level utility measure so that later context-window assembly reflects the determined ordering. Furthermore, as disclosed in FIGS. 3-6 earlier-described operations including sorted execution of tests, confidence-driven stopping, verbatim checking, and logit-matrix analysis, thereby providing support for implementations in which inference-time context selection relies on the same valuation framework used for contribution analysis more broadly.

The context window utility assessment step 2205 applies the contribution results across the candidate sequence set to determine which sequences provide utility for the model context window. More particularly, context window utility assessment step 2205 assesses contribution value in relation to the inference system as a whole and determines whether a given segmented input sequence warrants inclusion, exclusion, or reordering within the available context budget. The context-window utility assessment may consider whether a sequence is redundant with other retained sequences, whether the model has already exhibited familiarity with the sequence, whether the sequence contributes limited incremental information relative to competing sequences, or whether the sequence detracts from use of the available context capacity for the selected inference objective. In this stage, sequences associated with reduced or negative contribution value are discarded from the context candidate set or reordered relative to other sequences so that the context window is populated by a ranked set rather than an unfiltered collection. Additionally, context window utility assessment step 2205 supports the claim language directed to the steps of discarding or reordering input sequences having an expected reduced or negative contribution value and retaining remaining sequences for downstream resource allocation.

The optimal input sequence retention step 2206 selects and retains an optimal subset of input sequences for use in the inference-time context window. The retained subset may include those segmented input sequences that remain after the utility assessment and discard or reorder operations performed at context window utility assessment step 2205. The retained subset corresponds to the collection of candidate context inputs that the system determines to have greater utility for conditioning model output than excluded sequences. The retention at optimal input sequence retention step 2206 may preserve the ranked order produced earlier so that the retained subset is maintained as an ordered list, an annotated context set, a prompt assembly structure, a retrieval result object, or another data structure that identifies sequence membership and sequence position. Furthermore, the retained subset may include textual tokens, non-text encodings, or multimodal combinations, thereby supporting implementations in which the context window receives more than one data type. Additionally, optimal input sequence retention step 2206 provides figure-level support for claims directed to retaining remaining input sequences after discard or reorder operations based on contribution value determinations.

The optimal token allocation step 2207 determines how many tokens or related encodings are allocated to the retained subset within the model context window. The token allocation performed at optimal token allocation step 2207 may include assigning a sequence length to each retained input sequence, assigning relative portions of the context budget among retained sequences, truncating one or more retained sequences, concatenating retained sequences into a final prompt or multimodal context package, or otherwise mapping the retained subset into the representational capacity reserved at initial context window allocation step 2202. In implementations involving text, optimal token allocation step 2207 may assign an optimal number of tokens to the context window by placing retained token sequences into the context window in accordance with the sequence ordering determined at contribution value and ordering evaluation step 2204 and refined at context window utility assessment step 2205. In implementations involving non-text or mixed-modality content, optimal token allocation step 2207 may instead allocate encoded feature positions, embedding slots, frame positions, or related representational locations within the model input structure. Furthermore, this stage supports the claim language directed to determining context window allocation based on expected contribution value of input data used during inference, including implementations in which reduced-value sequences are omitted and remaining sequences occupy the available context capacity.

Moreover, the FIG. 22 progression from initial context window allocation step 2202 through optimal token allocation step 2207 provides support for a method or system in which input data is encoded, segmented into input sequences, evaluated for contribution value, and then used to govern inference-time context allocation. More particularly, FIG. 22 supports subject matter in which a processor receives the model and the input data, segments the input data into input sequences for testing, sorts or reorders the input sequences for input to the model, tests the model with each input sequence to determine expected contribution value, discards or reorders sequences associated with reduced or negative contribution value, retains remaining sequences, and allocates the context window based on the retained sequences. Additionally, FIG. 22 supports implementations in which the contribution analysis at contribution value and ordering evaluation step 2204 is based on entropy, significance, weight of evidence, explanatory power, rarity, salience, or combinations thereof, and in which the ranking of the segmented inputs is used to ensure that the context window is populated with sequences associated with greater expected utility to the inference task.

In some aspects of the disclosure, the workflow of FIG. 22 may be carried out on local computing infrastructure, cloud-based infrastructure, or a distributed combination thereof, using one or more CPUs, GPUs, accelerators, memories, and storage repositories such as those described with respect to FIGS. 2A and 2B. The segmented input sequences evaluated at input data segmentation step 2203, the valuation outputs generated at contribution value and ordering evaluation step 2204, the utility determinations made at context window utility assessment step 2205, and the retained context subset produced at optimal input sequence retention step 2206 may be stored as annotated records including contribution values, ranking information, confidence-related data, and sequence-selection metadata. Additionally, the inference process may iterate one or more stages of FIG. 22 when new candidate content becomes available, when the inference objective changes, or when the model response indicates that further context refinement is warranted. The process accordingly terminates at end 2208 after the model context window has been allocated in relation to the retained input sequences and corresponding token or encoding assignment.

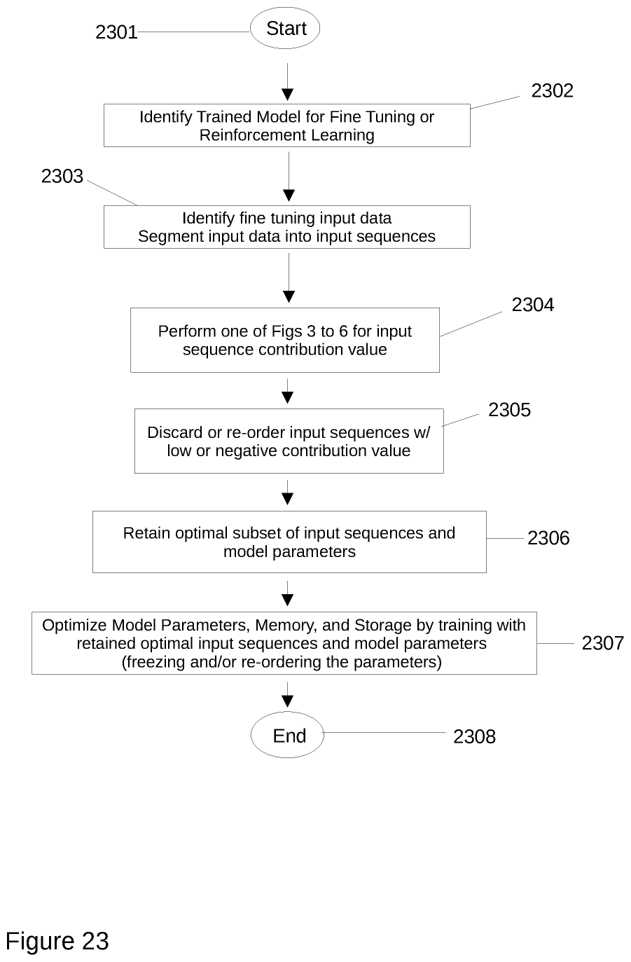

FIG. 23 is a flow chart illustrating a workflow in which contribution value determinations for segmented input sequences are used to select input sequences and model parameters for fine tuning or reinforcement learning of a trained model. The process begins at step 2301 and proceeds to identify a trained model for fine tuning or reinforcement learning step 2302, where a trained model is identified as a target for a post-training operation, such as fine tuning or reinforcement learning. The identify trained model for fine tuning or reinforcement learning step 2302 represents a model-selection stage in which the system identifies a trained model to be adapted through fine tuning or reinforcement learning. The model identified at identify trained model for fine tuning or reinforcement learning step 2302 may correspond to a pretrained language model, a multimodal model, a transformer-based model, a neural network model, a policy model used for reinforcement learning, a reward-conditioned model, or another trained predictive model having parameters available for post-training adjustment. In this stage, the system may load or otherwise access the trained model together with an associated model encoder, tokenizer, feature extractor, reward interface, policy-update module, or other components used during the selected post-training process. Additionally, the identification performed at identify trained model for fine tuning or reinforcement learning step 2302 may include determining which parameter groupings, layers, adapters, heads, policy components, value components, embedding components, or other trainable structures are candidates for later freezing, exclusion, retention, or reordering. Furthermore, by beginning with a trained model rather than an untrained model, the workflow of FIG. 23 supports the subject matter of the added claims directed to performing fine tuning or reinforcement learning on a model based on contribution values of input content used during fine tuning or reinforcement learning.

The input data segmentation step 2303 identifies fine-tuning input data and segments that input data into a plurality of input sequences that are suitable for contribution analysis and later post-training use. As described with respect to FIG. 22, the segmentation stage may operate on text, audio, video, images, music, mixed-modality content, instruction-response pairs, demonstration data, reward examples, preference data, prompt-completion pairs, conversational turns, or other content capable of being encoded for model evaluation. The segmentation performed at input data segmentation step 2303 may include token-based partitioning, sliding-window partitioning, prompt-completion partitioning, context-response partitioning, sequence labeling partitioning, masked-token partitioning, trajectory partitioning for reinforcement learning, or another procedure that yields separate candidate input sequences for testing. In implementations involving reinforcement learning, the segmented inputs may correspond to prompts, observations, state descriptions, action-conditioned contexts, feedback-bearing sequences, or related encoded units used to influence subsequent policy updates. Additionally, the input sequences produced at input data segmentation step 2303 may be organized into an enumerated collection for subsequent ranking, testing, reordering, discard operations, and retention in a manner consistent with the segmentation and test-enumeration procedures described with respect to FIGS. 10 and 11.

In one aspect, the perform contribution value determination for input sequence step 2304 performs contribution value determination for an input sequence by invoking one or more of the workflows described with respect to FIGS. 3-6. For a selected input sequence derived at input data segmentation step 2203, the system may obtain or initialize a model encoder, encode the content, identify a corresponding ground truth completion, define one or more tests to be performed in relation to the trained model, and obtain output token sequences, output encoding sequences, or logits associated with the selected input sequence. The contribution analysis carried out at perform contribution value determination for input sequence step 2304 may include determinations for rarity, salience, entropy, significance, weight of evidence, explanatory power, or related measures that characterize the informational value of the input sequence with respect to the target model. Additionally, the determination at perform contribution value determination for input sequence step 2304 may be based on verbatim-output analysis, logit-matrix analysis, sorted execution of tests, and confidence-driven stopping as described earlier in the disclosure. In this manner, the contribution value attributed to the input sequence may represent an expected contribution value for use in later fine tuning or reinforcement learning, a measured utility relative to the model in its present trained state, or another sequence-level valuation used to compare candidate post-training inputs against one another. The reference in the figure to performing one of FIGS. 3-6 ties FIG. 23 to the earlier-described token-level and sequence-level mechanisms for determining contribution value and seen-use status.

Next, the discard or reorder input sequences with low or negative contribution value step 2305 applies the contribution determinations generated at the perform contribution value determination for input sequence step 2304 to remove or rearrange candidate post-training inputs. More particularly, input sequences associated with reduced contribution value or negative contribution value are discarded from a fine-tuning set, excluded from a reinforcement-learning dataset, deprioritized relative to other candidate sequences, or reordered within a post-training schedule. A negative contribution value in this setting may correspond to a sequence that is assessed as redundant, detrimental to a selected objective, already overrepresented in the model, or otherwise not selected for continued use in post-training. Reordering at discard or reorder input sequences with low or negative contribution value step 2305 may include ranking the candidate sequences according to expected contribution value so that retained sequences are presented earlier, later, or in another selected order during fine tuning or reinforcement learning. Additionally, the operations performed at discard or reorder input sequences with low or negative contribution value step 2305 support the added claim language directed to discarding or reordering input encoding sequences having reduced or negative contribution value and retaining the remaining input sequences for downstream model operations. Furthermore, the discard or reorder operation may be carried out after confidence evaluation so that action is taken after the system has accumulated an amount of evidence sufficient for the intended determination.

The retain optimal subset of input sequences and model parameters step 2306 retains an optimal subset of input sequences together with a retained set of model parameters for the forthcoming post-training, fine-tuning or reinforcement-learning procedure. The retained subset may include those input sequences that remain after the discard and reorder operations performed at discard or reorder input sequences with low or negative contribution value step 2305, and may be maintained as a ranked sequence list, a curated post-training dataset, a selected replay buffer entry set, an annotated prompt collection, or another structured data object. The retained model parameters selected at the retain optimal subset of input sequences and model parameters step 2306 may include parameters that remain trainable during the post-training operation, while other parameters are frozen, withheld from update, excluded from gradient computation, or reordered in an update schedule. For example, the retained parameter set may include adapter layers, selected transformer blocks, attention modules, feed-forward modules, embedding layers, reward-model parameters, policy-head parameters, value-head parameters, low-rank adaptation parameters, or other trainable parameter groupings associated with the retained sequence subset. Additionally, retain optimal subset of input sequences and model parameters step 2306 supports joint selection of data and parameter resources so that the post-training workflow acts on a coordinated set of retained inputs and retained trainable structures rather than selecting input data in isolation.

Next, the optimize model parameters, memory, and storage by training with retained optimal input sequences and model parameters step 2307 performs a resource-allocation and post-training stage in which the trained model is adapted using the retained optimal input sequences and retained model parameters. As indicated in the figure, the post-training at optimize model parameters, memory, and storage by training with retained optimal input sequences and model parameters step 2307 may include freezing and/or reordering the parameters used during training so that update activity is directed toward the retained parameter subset while excluded parameters remain outside the active update path. In implementations involving fine tuning, the retained input sequences may be supplied as supervised examples, prompt-completion pairs, instruction-following examples, domain-adaptation sequences, or other adaptation inputs that cause the retained model parameters to be updated in relation to a selected objective. In implementations involving reinforcement learning, the retained input sequences may be supplied as prompts, state encodings, action contexts, preference-related examples, reward-related examples, or trajectory-related data that influence policy updates, reward-model updates, value estimation, or related reinforcement-learning operations. Additionally, the optimization performed at optimize model parameters, memory, and storage by training with retained optimal input sequences and model parameters step 2307 may include reducing memory allocation associated with excluded parameter updates, reducing storage allocation associated with discarded input sequences, and allocating processing resources in relation to the retained post-training set. Furthermore, because optimize model parameters, memory, and storage by training with retained optimal input sequences and model parameters step 2307 follows the sequence-selection and parameter-selection stages shown earlier in the figure, the model adaptation carried out at this stage is governed by contribution value determinations rather than by unfiltered use of the available post-training content.

Moreover, FIG. 23 provides the progression from identify trained model for fine tuning or reinforcement learning step 2302 through optimize model parameters, memory, and storage by training with retained optimal input sequences and model parameters step 2307 provides support for the subject matter introduced in the updated claims directed to performing fine tuning or reinforcement learning on a model based on contribution values of input content used during those operations. FIG. 23 supports a system or method in which a processor supplies input content to a model and obtains corresponding outputs, a model encoder encodes the input content into a sequence of encodings representative of the input content, the processor performs a plurality of tests in relation to the model for each input sequence and corresponding output encoding sequence, the processor combines results of the plurality of tests for each output encoding sequence to obtain a value representative of contribution value for the input encoding sequence to the model, and the processor then discards or reorders reduced-value sequences while retaining remaining input sequences. The figure further supports implementations in which the processor performs fine tuning or reinforcement learning of the model based on the remaining input encoding sequences and selected model parameters. Additionally, FIG. 23 supports implementations in which the tests are performed in a sorted order, continued until a confidence condition is satisfied, and based on determinations for entropy, significance, weight of evidence, explanatory power, rarity, salience, or combinations thereof, consistent with the added claims and the earlier disclosure.

In some aspects of the disclosure, the workflow of FIG. 23 may be carried out on local computing infrastructure, cloud-based infrastructure, or a distributed combination thereof, using one or more CPUs, GPUs, accelerators, memories, and storage repositories such as those described with respect to FIGS. 2A and 2B. The trained model identified at identify trained model for fine tuning or reinforcement learning step 2302, the segmented input sequences produced at input data segmentation step 2203, the contribution values determined at perform contribution value determination for input sequence step 2304, the discard or reorder results generated at discard or reorder input sequences with low or negative contribution value step 2305, and the retained subset and retained parameter set produced at retain optimal subset of input sequences and model parameters step 2306 may be stored as annotated records that include sequence identifiers, contribution values, ranking information, confidence-related data, and parameter-selection metadata. Additionally, one or more stages of FIG. 23 may be iterated during post-training such that later batches of content are segmented and re-evaluated as the model state changes. Furthermore, the process terminates at end 2308 after the fine-tuning or reinforcement-learning operation has been performed using the retained optimal input sequences and retained model parameters, with the resulting model reflecting the contribution-based selection process shown in the figure.

According to one embodiment of the present disclosure, a non-transitory computer-readable medium stores instructions that, when executed by one or more processors, cause a system to determine memory, storage, or model parameter allocation based on an expected contribution value of input data used by a model during training or inference, the instructions causing the system to: receive the model and the input data; encode the input data and segment the input data into input sequences for testing; sort the input sequences into a sorted order for input to the model; test the model with each input sequence by obtaining output token sequences and logit values correlated to each input sequence, and by computing entropy, significance, weight of evidence, or explanatory power to determine the expected contribution value of each input sequence; discard or reorder each input sequence having an expected low or negative contribution value and retain remaining input sequences; and allocate the memory, storage, or model parameters for the remaining input sequences.

The instructions may further cause the one or more processors to determine, based on tests, whether an input sequence of the input sequences was seen during training or inference, terminate the tests when sufficient evidence is obtained, or report an inconclusive result when sufficient evidence is not obtained.

The input data may include text, audio, video, images, or music, and wherein encoding the input data includes at least one of: tokenizing the input data to obtain a sequence of tokens representative of content of the input data; computing feature maps of the video or the images; and computing feature vectors of the audio or the music.

The sorting the input sequences into the sorted order may include ranking each of the input sequences based on the expected contribution value of the input sequence to reach sufficient evidence using the input sequences.

The model may include a model vocabulary, and wherein the instructions to compute the weight of evidence and the explanatory power include instructions to compare one of the input sequences with the model vocabulary.

According to one embodiment of the present disclosure, a non-transitory computer-readable medium stores instructions that, when executed by one or more processors, cause a system to determine a context window allocation based on expected contribution value of input data used by a model during inference, the instructions causing the system to: receive the model and the input data; encode the input data and segment the input data into input sequences for testing; sort the input sequences into a sorted order for input to the model; test the model with each input sequence by obtaining output token sequences and logit values correlated to each input sequence, and by computing entropy, significance, weight of evidence, or explanatory power to determine the expected contribution value of each input sequence; discard or reorder each input sequence having an expected low or negative contribution value and retain remaining input sequences; and update the context window allocation for the remaining input sequences.

According to one embodiment of the present disclosure, a non-transitory computer-readable medium stores instructions that, when executed by one or more processors, cause a system to minimize a number of steps or tokens used during model training or inference based on expected contribution value of input data used by a model during training or inference, the instructions causing the system to: receive the model and the input data; encode the input data and segment the input data into input sequences for testing; sort the input sequences into a sorted order for input to the model; test the model with each input sequence by obtaining output encoding sequences and logit values correlated to each input sequence, and by computing entropy, significance, weight of evidence, or explanatory power to determine the expected contribution value of each input sequence; discard or reorder each input sequence having an expected low or negative contribution value and retain remaining input sequences; and perform the model training or inference with the remaining input sequences.

According to one embodiment of the present disclosure, a system for determining memory, storage, or model parameter allocation based on contribution values of input content used by a model during training or inference includes: a processor configured to supply the input content to the model and obtain corresponding outputs from the model; and a model encoder for the model, configured to encode the input content into a sequence of encodings representative of the input content; wherein the processor is further configured to: perform a plurality of tests in relation to the model with each input sequence of the input content and a corresponding output token sequence, wherein the plurality of tests include determinations for rarity or salience; combine results of the plurality of tests for each output sequence to obtain a value representative of a contribution value for the input sequence to the model; discard or reorder each input sequence having an expected low or negative contribution value and retain remaining input sequences; and allocate memory, storage, or model parameters based on the remaining input sequences.

The processor may include a graphics processing unit or a central processing unit.

The processor may be located locally on a computer or remotely on a cloud-based server system.

The input sequence may include text, audio, video, images, or music.

The processor may be further configured to perform the plurality of tests in a sorted order, and wherein the model encoder may be configured to tokenize the input content into a sequence of tokens representative of the input content.

The processor may be further configured to perform the plurality of tests until sufficient confidence of the tests is determined.

The processor may be further configured to perform determinations for significance, entropy, weight of evidence, or explanatory power.

The processor may be further configured to perform tests for significance and entropy to determine a sorted order of the tests.

The processor may be further configured to rank each of the tests based on an expected contribution value of the test to reach sufficient confidence using the plurality of tests.

The processor may be further configured to combine the results of the plurality of tests for each output sequence of a plurality of output sequences to obtain a value representative of the contribution value for the input sequence, wherein the plurality of tests may further include determinations for significance, entropy, weight of evidence, or explanatory power.

The processor may be further configured to compare the plurality of output sequences with a plurality of ground truth tokens for a corresponding input sequence in performing determinations for significance and entropy.

The model may include a model vocabulary and the processor is further configured to compare one of the plurality of tests with the model vocabulary in performing determinations for weight of evidence and explanatory power.

The processor may be further configured to determine context window allocation based on the contribution value of input content used by the model during inference.

According to one embodiment of the present disclosure, a system for determining context window allocation based on contribution values of input content used by a model during inference includes: a processor configured to supply the input content to the model and obtain corresponding outputs from the model; and a model encoder for the model, configured to encode the input content into a sequence of tokens representative of the input content; wherein the processor is further configured to: perform a plurality of tests in relation to the model for each input sequence and a corresponding output encoding sequence, wherein the plurality of tests include determinations for rarity or salience; combine results of the plurality of tests for each output encoding sequence to obtain a value representative of a contribution value for the input sequence to the model; discard or reorder each input sequence having an expected low or negative contribution value and retain remaining input sequences; and update the context window allocation based on the remaining input sequences.

According to one embodiment of the present disclosure, a system for minimizing a number of steps or tokens used during model training or inference based on expected contribution value for input content used by a model during training or inference includes: a processor configured to supply the input content to the model and obtain corresponding outputs from the model; and a model encoder for the model, configured to encode the input content into a sequence of encodings representative of the input content; wherein the processor is further configured to: perform a plurality of tests in relation to the model for each input sequence and a corresponding output encoding sequence, wherein the plurality of tests include determinations for rarity or salience; combine results of the plurality of tests for each output encoding sequence to obtain a value representative of a contribution value for the input sequence to the model; discard or reorder each input sequence having an expected low or negative contribution value and retain remaining input sequences; and perform the model training or inference with the remaining input sequences.

According to one embodiment of the present disclosure, a system for performing fine tuning or reinforcement learning on a model based on contribution values of input content used during fine tuning or reinforcement learning includes: a processor configured to supply the input content to the model and obtain corresponding outputs from the model; and a model encoder for the model, configured to encode the input content into a sequence of tokens representative of the input content; wherein the processor is further configured to: perform a plurality of tests in relation to the model for each input sequence and a corresponding output encoding sequence, wherein the plurality of tests include determinations for rarity or salience; combine results of the plurality of tests for each output encoding sequence to obtain a value representative of a contribution value for the input sequence to the model; discard or reorder each input sequence having an expected low or negative contribution value and retain remaining input sequences; and perform fine tuning or reinforcement learning of the model based on the remaining input sequences.

According to one embodiment of the present disclosure, a method of determining input content to use with a model based on contribution values of the input content includes: supplying the input content to the model and obtaining corresponding outputs from the model; encoding the input content into a sequence of encodings representative of the input content; performing a plurality of tests in relation to the model with each input sequence of the input content and a corresponding output sequence, wherein the plurality of tests include determinations for rarity or salience; combining results of the plurality of tests for each output sequence to obtain a value representative of a contribution value for the input sequence to the model; and discarding or reordering each input sequence having an expected low or negative contribution value and retaining remaining input sequences.

The method may further include allocating memory, storage, or model parameters based on the remaining input sequences.

The method may further include allocating a context window based on the remaining input sequences.

The method may further include fine tuning or reinforcement learning the model based on the remaining input sequences.

The method may include using a graphics processing unit or a central processing unit.

The graphics processing unit or the central processing unit may be located locally on a computer or remotely on a cloud-based server system.

The input content may include text, audio, video, images, or music.

The method may further include performing the plurality of tests in a sorted order and tokenizing the input content into a sequence of tokens representative of the input content.

The method may further include performing the plurality of tests until sufficient confidence of the tests is determined.

The method may further include performing determinations for significance, entropy, weight of evidence, or explanatory power.

The method may further include performing tests for significance and entropy to determine a sorted order of the tests.

The method may further include ranking each of the tests based on an expected contribution value of the test to reach sufficient confidence using the plurality of tests.

The method may further include combining a plurality of test results for each output token sequence of a plurality of output token sequences to obtain a value representative of the contribution value for the output token sequence, wherein the plurality of tests further include determinations for significance, entropy, weight of evidence, or explanatory power.

The method may further include comparing the plurality of output token sequences with a plurality of ground truth tokens for a corresponding input sequence in performing determinations for significance and entropy.

The model may include a model vocabulary, and the method may further include comparing one of a plurality of tests with the model vocabulary in performing determinations for weight of evidence and explanatory power.

The term non-transitory computer-readable medium is to be understood herein to refer to one or more non-transitory computer-readable media, such as a single solid-state drive, multiple solid-state drives connected in a redundant array of independent drives, one or more hard disk drives (e.g., magnetic data storage media), one or more optical (e.g., CD-ROM or DVD-ROM) media, one or more pools of data storage devices connected to one or more computer servers, and the like.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A non-transitory computer-readable medium storing instructions that, when executed by one or more processors, cause a system to determine memory, storage, or model parameter allocation based on an expected contribution value of input data used by a model during training or inference, the instructions causing the system to:
receive the model and the input data;
encode the input data and segment the input data into input sequences for testing;
sort the input sequences into a sorted order for input to the model;
test the model with each input sequence by obtaining output token sequences and logit values correlated to each input sequence, and by computing entropy, significance, weight of evidence, or explanatory power to determine the expected contribution value of each input sequence;
discard or reorder each input sequence having an expected low or negative contribution value and retain remaining input sequences; and
allocate the memory, storage, or model parameters for the remaining input sequences.

2. The non-transitory computer-readable medium of claim 1, wherein the instructions further cause the one or more processors to determine, based on tests, whether an input sequence of the input sequences was seen during training or inference, terminate the tests when sufficient evidence is obtained, or report an inconclusive result when sufficient evidence is not obtained.

3. The non-transitory computer-readable medium of claim 2, wherein the input data comprises text, audio, video, images, or music, and wherein encoding the input data comprises at least one of:
tokenizing the input data to obtain a sequence of tokens representative of content of the input data;
computing feature maps of the video or the images; and
computing feature vectors of the audio or the music.

4. The non-transitory computer-readable medium of claim 2, wherein sorting the input sequences into the sorted order comprises ranking each of the input sequences based on the expected contribution value of the input sequence to reach sufficient evidence using the input sequences.

5. The non-transitory computer-readable medium of claim 2, wherein the model comprises a model vocabulary, and wherein the instructions to compute the weight of evidence and the explanatory power comprise instructions to compare one of the input sequences with the model vocabulary.

6. A non-transitory computer-readable medium storing instructions that, when executed by one or more processors, cause a system to determine a context window allocation based on expected contribution value of input data used by a model during inference, the instructions causing the system to:
receive the model and the input data;
encode the input data and segment the input data into input sequences for testing;
sort the input sequences into a sorted order for input to the model;
test the model with each input sequence by obtaining output token sequences and logit values correlated to each input sequence, and by computing entropy, significance, weight of evidence, or explanatory power to determine the expected contribution value of each input sequence;
discard or reorder each input sequence having an expected low or negative contribution value and retain remaining input sequences; and
update the context window allocation for the remaining input sequences.

7. A non-transitory computer-readable medium storing instructions that, when executed by one or more processors, cause a system to minimize a number of steps or tokens used during model training or inference based on expected contribution value of input data used by a model during training or inference, the instructions causing the system to:
receive the model and the input data;
encode the input data and segment the input data into input sequences for testing;
sort the input sequences into a sorted order for input to the model;
test the model with each input sequence by obtaining output encoding sequences and logit values correlated to each input sequence, and by computing entropy, significance, weight of evidence, or explanatory power to determine the expected contribution value of each input sequence;
discard or reorder each input sequence having an expected low or negative contribution value and retain remaining input sequences; and
perform the model training or inference with the remaining input sequences.

8. A system for determining memory, storage, or model parameter allocation based on contribution values of input content used by a model during training or inference, the system comprising:
a processor configured to supply the input content to the model and obtain corresponding outputs from the model; and
a model encoder for the model, configured to encode the input content into a sequence of encodings representative of the input content;
wherein the processor is further configured to:
perform a plurality of tests in relation to the model with each input sequence of the input content and a corresponding output token sequence, wherein the plurality of tests comprise determinations for rarity or salience;
combine results of the plurality of tests for each output sequence to obtain a value representative of a contribution value for the input sequence to the model;
discard or reorder each input sequence having an expected low or negative contribution value and retain remaining input sequences; and
allocate memory, storage, or model parameters based on the remaining input sequences.

9. The system of claim 8, wherein the processor comprises a graphics processing unit or a central processing unit.

10. The system of claim 9, wherein the processor is located locally on a computer or remotely on a cloud-based server system.

11. The system of claim 8, wherein the input sequence comprises text, audio, video, images, or music.

12. The system of claim 8, wherein the processor is further configured to perform the plurality of tests in a sorted order, and wherein the model encoder is configured to tokenize the input content into a sequence of tokens representative of the input content.

13. The system of claim 8, wherein the processor is further configured to perform the plurality of tests until sufficient confidence of the tests is determined.

14. The system of claim 8, wherein the processor is further configured to perform determinations for significance, entropy, weight of evidence, or explanatory power.

15. The system of claim 14, wherein the processor is further configured to perform tests for significance and entropy to determine a sorted order of the tests.

16. The system of claim 12, wherein the processor is further configured to rank each of the tests based on an expected contribution value of the test to reach sufficient confidence using the plurality of tests.

17. The system of claim 8, wherein the processor is further configured to combine the results of the plurality of tests for each output sequence of a plurality of output sequences to obtain a value representative of the contribution value for the input sequence, wherein the plurality of tests further comprise determinations for significance, entropy, weight of evidence, or explanatory power.

18. The system of claim 17, wherein the processor is further configured to compare the plurality of output sequences with a plurality of ground truth tokens for a corresponding input sequence in performing determinations for significance and entropy.

19. The system of claim 17, wherein the model comprises a model vocabulary and the processor is further configured to compare one of the plurality of tests with the model vocabulary in performing determinations for weight of evidence and explanatory power.

20. The system of claim 8, wherein the processor is further configured to determine context window allocation based on the contribution value of input content used by the model during inference.

21. A system for determining context window allocation based on contribution values of input content used by a model during inference, the system comprising:
a processor configured to supply the input content to the model and obtain corresponding outputs from the model; and
a model encoder for the model, configured to encode the input content into a sequence of tokens representative of the input content;
wherein the processor is further configured to:
perform a plurality of tests in relation to the model for each input sequence and a corresponding output encoding sequence, wherein the plurality of tests comprise determinations for rarity or salience;
combine results of the plurality of tests for each output encoding sequence to obtain a value representative of a contribution value for the input sequence to the model;
discard or reorder each input sequence having an expected low or negative contribution value and retain remaining input sequences; and
update the context window allocation based on the remaining input sequences.

22. A system for minimizing a number of steps or tokens used during model training or inference based on expected contribution value for input content used by a model during training or inference, the system comprising:
a processor configured to supply the input content to the model and obtain corresponding outputs from the model; and
a model encoder for the model, configured to encode the input content into a sequence of encodings representative of the input content;
wherein the processor is further configured to:
perform a plurality of tests in relation to the model for each input sequence and a corresponding output encoding sequence, wherein the plurality of tests comprise determinations for rarity or salience;
combine results of the plurality of tests for each output encoding sequence to obtain a value representative of a contribution value for the input sequence to the model;
discard or reorder each input sequence having an expected low or negative contribution value and retain remaining input sequences; and
perform the model training or inference with the remaining input sequences.

23. A system for performing fine tuning or reinforcement learning on a model based on contribution values of input content used during fine tuning or reinforcement learning, the system comprising:
a processor configured to supply the input content to the model and obtain corresponding outputs from the model; and
a model encoder for the model, configured to encode the input content into a sequence of tokens representative of the input content;
wherein the processor is further configured to:
perform a plurality of tests in relation to the model for each input sequence and a corresponding output encoding sequence, wherein the plurality of tests comprise determinations for rarity or salience;
combine results of the plurality of tests for each output encoding sequence to obtain a value representative of a contribution value for the input sequence to the model;
discard or reorder each input sequence having an expected low or negative contribution value and retain remaining input sequences; and
perform fine tuning or reinforcement learning of the model based on the remaining input sequences.

24. A method of determining input content to use with a model based on contribution values of the input content, the method comprising:
supplying the input content to the model and obtaining corresponding outputs from the model;
encoding the input content into a sequence of encodings representative of the input content;
performing a plurality of tests in relation to the model with each input sequence of the input content and a corresponding output sequence, wherein the plurality of tests comprise determinations for rarity or salience;
combining results of the plurality of tests for each output sequence to obtain a value representative of a contribution value for the input sequence to the model; and
discarding or reordering each input sequence having an expected low or negative contribution value and retaining remaining input sequences.

25. The method of claim 24, further comprising allocating memory, storage, or model parameters based on the remaining input sequences.

26. The method of claim 24, further comprising allocating a context window based on the remaining input sequences.

27. The method of claim 24, further comprising fine tuning or reinforcement learning the model based on the remaining input sequences.

28. The method of claim 24, wherein the method comprises using a graphics processing unit or a central processing unit.

29. The method of claim 28, wherein the graphics processing unit or the central processing unit is located locally on a computer or remotely on a cloud-based server system.

30. The method of claim 24, wherein the input content comprises text, audio, video, images, or music.

31. The method of claim 24, further comprising performing the plurality of tests in a sorted order and tokenizing the input content into a sequence of tokens representative of the input content.

32. The method of claim 24, further comprising performing the plurality of tests until sufficient confidence of the tests is determined.

33. The method of claim 24, further comprising performing determinations for significance, entropy, weight of evidence, or explanatory power.

34. The method of claim 33, further comprising performing tests for significance and entropy to determine a sorted order of the tests.

35. The method of claim 31, further comprising ranking each of the tests based on an expected contribution value of the test to reach sufficient confidence using the plurality of tests.

36. The method of claim 24, further comprising combining a plurality of test results for each output token sequence of a plurality of output token sequences to obtain a value representative of the contribution value for the output token sequence, wherein the plurality of tests further comprise determinations for significance, entropy, weight of evidence, or explanatory power.

37. The method of claim 36, further comprising comparing the plurality of output token sequences with a plurality of ground truth tokens for a corresponding input sequence in performing determinations for significance and entropy.

38. The method of claim 36, wherein the model comprises a model vocabulary, the method further comprising comparing one of a plurality of tests with the model vocabulary in performing determinations for weight of evidence and explanatory power.
